(19) United States
(12) Patent Application Publication
(10) Pub. No.: US 2026/0339683 A1
(43) Pub. Date: Oct. 29, 2026

(54) Computing Systems and Graphical User Interfaces for Input Localization in a Multiresponse System

(71) Applicant: JMP Statistical Discovery LLC, Cary, NC (US)

(72) Inventors: Yi Ji, Raleigh, NC (US); Joseph Albert Morgan, Raleigh, NC (US); Ryan Adam Lekivetz, Cary, NC (US)

(21) Appl. No.: 19/366,992

(22) Filed: Oct. 23, 2025

Related U.S. Application Data
(60) Provisional application No. 63/793,409, filed on Apr. 23, 2025.

(51) Int. Cl. G06F 9/451; G06F 3/0482

(52) U.S. Cl. CPC G06F 9/451; G06F 3/0482

(57) ABSTRACT

A computing system receives an authorized extent of computational processing via a control element of a graphical user interface (GUI). The computing system dynamically allocates resources at the computing system for generating localization factors. The localization factors are for localizing factors influencing a given outcome for the experiment or an experiment model. The computing system receives an assignment via the input element of the GUI. The assignment indicates an estimation as to a contribution of a recipient of the assignment to an estimated outcome for the experiment. The computing system obtains outcome data indicating outcomes from conducting the experiment or executing the experiment model. The computing system controls the GUI to display a computer-generated prediction for the outcome data by generating, based on the outcome data, the authorized extent of computational processing, and the assignment, a ranking of combinations of factors from localization factors.

### CROSS-REFERENCE TO RELATED APPLICATIONS

This application claims the benefit of, and priority based on, 35 U.S.C. § 119 to U.S. Provisional Application No. 63/793,409, filed Apr. 23, 2025, the disclosures of which are incorporated herein by reference in their entirety.

### BACKGROUND

In a complex system, different components work together to function as the complex system. For example, an airplane may have electrical, mechanical and software components that work together for the airplane to land. An engineer may have different options for a given component in the system (e.g., different control systems or different settings for a control system for the landing gear of the airplane). An engineer testing a complex system can construct a test suite that represents different test cases for the system with selections for the different options for each of the components in the system. In some situations, the test engineer is faced with the task of identifying the option or combination of options that precipitated a given outcome to the test (e.g., a failure).

### SUMMARY

In an example embodiment, a computer-program product tangibly embodied in a non-transitory machine-readable storage medium is provided. The computer-program product includes instructions operable to cause a computing system to display a graphical user interface. The graphical user interface comprises a set of multiple factors for an experiment; a control element for controlling an extent of computational processing for the set of multiple factors; and an input element for receiving an assignment to at least one factor or at least one combination of factors from the set of multiple factors. The assignment indicates an estimation as to a contribution of a recipient of the assignment to an estimated outcome for the experiment. The computer-program product includes instructions operable to cause a computing system to receive an indication of an authorized extent of computational processing via the control element. The computer-program product includes instructions operable to cause a computing system to, based on the indication of the authorized extent of computational processing, dynamically allocate resources at the computing system for generating a set of localization factors. The set of localization factors are for localizing one or more of the set of multiple factors influencing a given outcome for the experiment or an experiment model for the experiment. The computer-program product includes instructions operable to cause a computing system to receive the assignment via the input element of the graphical user interface. The computer-program product includes instructions operable to cause a computing system to obtain outcome data that is based on conducting the experiment or executing the experiment model. The outcome data indicates at least two outcomes from conducting the experiment or executing the experiment model. The computer-program product includes instructions operable to cause a computing system to control the graphical user interface to display a computer-generated prediction for the outcome data by generating, based on the outcome data, the indication of the authorized extent of computational processing, and the assignment, a ranking of a first combination of factors and a second combination of factors from the set of localization factors. The first combination of factors and the second combination of factors are different. The ranking is based on a computer-generated model of a contribution of the set of localization factors to a given outcome of the at least two outcomes.

In another example embodiment, a computing system is provided. The computing system includes, but is not limited to, a processor and memory. The memory contains instructions that when executed by the processor control the computing system to control the graphical user interface to display a computer-generated prediction for the outcome data.

In another example embodiment, a method of controlling the graphical user interface to display a computer-generated prediction for the outcome data is provided.

Other features and aspects of example embodiments are presented below in the Detailed Description when read in connection with the drawings presented with this application.

### BRIEF DESCRIPTION OF THE DRAWINGS

FIG. 1 illustrates an example network, including an example set of devices communicating with each other, according to at least one embodiment of the present technology.

FIG. 2 illustrates a block diagram that provides an illustration of the hardware components of a first computing system according to at least one embodiment of the present technology.

FIG. 3 illustrates a portion of a communications grid first computing system, including a control node and a worker node, according to at least one embodiment of the present technology.

FIG. 4 illustrates a block diagram of example applications according to at least one embodiment of the present technology.

FIG. 5 illustrates a flow chart of an example of a process for generating and using a machine-learning model according to at least one embodiment of the present technology.

FIG. 6 illustrates an example of a machine-learning model as a neural network according to at least one embodiment of the present technology.

FIG. 7 illustrates a block diagram of a system for generating computer-generated predictions for factor(s) contributing to an outcome according to at least one embodiment of the present technology.

FIG. 8 illustrates a flow diagram for generating computer-generated predictions for factor(s) contributing to an outcome according to at least one embodiment of the present technology.

FIGS. 9A-9G illustrate graphical user interface(s) for indicating a ranking of combinations of factors with custom input to weighted priors according to at least one embodiment of the present technology.

FIGS. 10A-10C illustrate graphical user interface(s) for receiving custom input to a weighted prior for an individual factor according to at least one embodiment of the present technology.

FIGS. 11A-11B illustrate graphical user interface(s) for receiving assisted input to a weighted prior for an individual factor according to at least one embodiment of the present technology.

FIGS. 12A-12B illustrate graphical user interface(s) for receiving batch weighted priors to individual factors according to at least one embodiment of the present technology.

FIGS. 13A-13B illustrate graphical user interface(s) for receiving weighted priors for a combinations of factors according to at least one embodiment of the present technology.

FIGS. 14A-14B illustrate graphical user interface(s) for unweighted priors according to at least one embodiment of the present technology.

FIGS. 15A-15F illustrate graphical user interface(s) for indicating a ranking of combinations of factors with assisted input to weighted priors according to at least one embodiment of the present technology.

FIG. 16 illustrates a graphical user interface for different weighted priors according to at least one embodiment of the present technology.

FIG. 17 illustrates a flow diagram for selecting candidate causes for a test suite according to at least one embodiment of the present technology.

FIGS. 18A-18C illustrates graphical user interface(s) for receiving a limit for a quantity of candidate causes according to at least one embodiment of the present technology.

FIG. 19A illustrates candidate causes according to at least one embodiment of the present technology.

FIG. 19B illustrates a bipartite mapping according to at least one embodiment of the present technology.

FIG. 19C illustrates a flow diagram for a set cover enumeration according to at least one embodiment of the present technology.

FIGS. 20A-20F illustrates generating subsets of candidate causes based on different processing limits according to at least one embodiment of the present technology.

### DETAILED DESCRIPTION

In the following description, for the purposes of explanation, specific details are set forth in order to provide a thorough understanding of embodiments of the technology. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the technology as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional operations not included in a figure. A process may correspond to a method, a function, a procedure, a subroutine, a subprogram, etc. When a process corresponds to a function, its termination can correspond to a return of the function to the calling function or the main function.

Systems depicted in some of the figures may be provided in various configurations. In some embodiments, the systems may be configured as a distributed system where one or more components of the system are distributed across one or more networks in a cloud computing system.

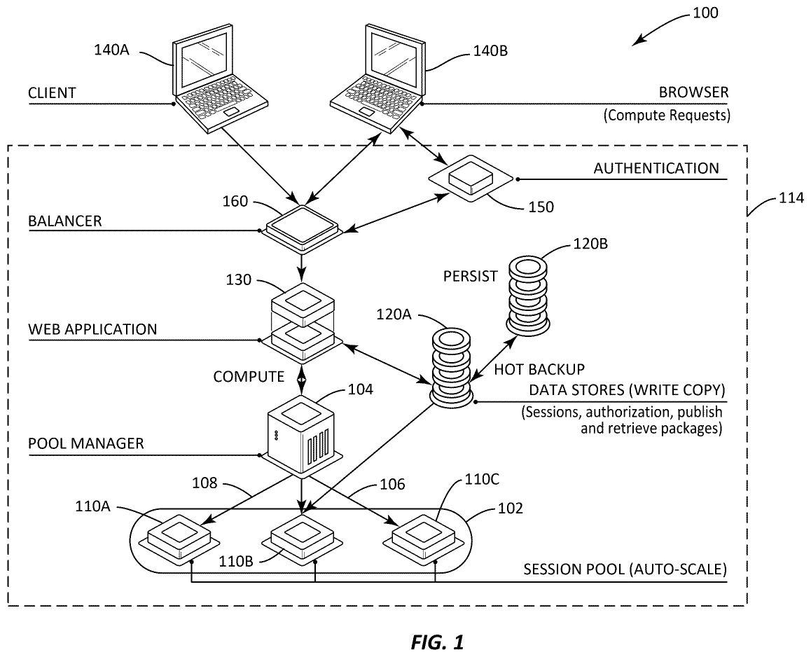

FIG. 1 illustrates an example network 100 including an example set of devices communicating with each other (e.g., over one or more of an exchange system or a network), according to embodiments of the present technology. Network 100 includes network devices configured to communicate with a variety of types of client devices, for example, client devices 140, over a variety of types of communication channels. A client device 140 may be configured to communicate over a public or private network (e.g., client device 140B is configured to support a browser for computing requests or providing authentication).

Network devices and client devices can transmit a communication over a network 100. Network 100 may include one or more of different types of networks, including a wireless network, a wired network, or a combination of a wired and wireless network. Examples of suitable networks include the Internet, a personal area network, a local area network (LAN), a wide area network (WAN), a wireless local area network (WLAN), cloud network, or a cellular network. A wireless network may include a wireless interface or combination of wireless interfaces. As an example, a network in the one or more networks may include a short-range communication channel, such as a Bluetooth or a Bluetooth Low Energy channel. A wired network may include a wired interface. The wired and/or wireless networks may be implemented using routers, access points, base stations, bridges, gateways, or the like, to connect devices in the network. The one or more networks can be incorporated entirely within or can include an intranet, an extranet, or a combination thereof. In one embodiment, communications between two or more systems and/or devices can be achieved by a secure communications protocol, such as secure sockets layer (SSL) or transport layer security (TLS), or other available protocols such as according to an Open Systems Interaction model. In addition, data and/or transactional details may be encrypted. Networks may include other devices for infrastructure for the network. For example, a cloud network may include cloud infrastructure system on demand. As another example, one or more client devices may utilize an Internet of Things (IoT) infrastructure where things (e.g., machines, devices, phones, sensors) can be connected to networks and the data from these things can be collected and processed within the things and/or external to the things. IoT may be implemented with various infrastructure such as for accessibility (technologies that get data and move it), embed-ability (devices with embedded sensors), and IoT services. Industries in the IoT space may include automotive (connected car), manufacturing (connected factory), smart cities, energy and retail.

Network devices and client devices can be different types of devices or components of devices. For example, client device 140 is shown as a laptop and balancer 160 is shown as a processor. Client devices and network devices could be other types of devices or components of other types of devices such as a mobile phone, laptop computer, tablet computer, temperature sensor, motion sensor, and audio sensor. Additionally, or alternatively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, and flow rate sensors. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, and electrical current. The sensors may be mounted to various components used as part of a variety of different types of systems (e.g., an oil drilling operation). The network devices may detect and record data related to the environment that it monitors, and transmit that data to network 100.

As noted, one type of system that may include various sensors that collect data to be processed and/or transmitted to a computing environment (not shown) according to certain embodiments includes an oil drilling system. For example, the one or more drilling operation sensors may include, for example, surface sensors that measure a standpipe pressure, a surface torque, and a rotation speed of a drill pipe, and downhole sensors that measure a rotation speed of a bit and fluid densities. Besides the raw data collected directly by the sensors, other data may include parameters either developed by the sensors or assigned to the system by a client or other controlling device. For example, one or more drilling operation control parameters may control settings such as a mud motor speed to flow ratio, a bit diameter, a predicted formation top, seismic data, weather data, etc. Other data may be generated using physical models such as an earth model, a weather model, a seismic model, a bottom hole assembly model, a well plan model, an annular friction model, etc. In addition to sensor and control settings, predicted outputs, of for example, the rate of penetration and pump pressure may also be stored and used for modeling, prediction, or classification.

In another example, another type of system that may include various sensors that collect data to be processed and/or transmitted to a computing environment according to certain embodiments includes a home automation or similar automated network in a different environment, such as an office space, school, public space, sports venue, or a variety of other locations. Network devices in such an automated network may include network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). For example, network device or client device may include a home automation switch that may be coupled with a home appliance. In another embodiment, a network or client device can allow a user to access, control, and/or configure devices, such as office-related devices (e.g., copy machine, printer, or fax machine), audio and/or video related devices (e.g., a receiver, a speaker, a projector, a DVD player, or a television), media-playback devices (e.g., a compact disc player, a CD player, or the like), computing devices (e.g., a home computer, a laptop computer, a tablet, a personal digital assistant (PDA), a computing device, or a wearable device), lighting devices (e.g., a lamp or recessed lighting), devices associated with a security system, devices associated with an alarm system, devices that can be operated in an automobile (e.g., radio devices, navigation devices), and/or the like. Data may be collected from such various sensors in raw form, or data may be processed by the sensors to create parameters or other data either developed by the sensors based on the raw data or assigned to the system by a client or other controlling device.

In another example, another type of system that may include various sensors that collect data to be processed and/or transmitted to a computing environment (e.g., computing environment or another computing environment not shown) according to certain embodiments includes a manufacturing environment (e.g., manufacturing products or energy). A variety of different network devices may be included in an energy pool, such as various devices within one or more power plants, energy farms (e.g., wind farm, and solar farm) energy storage facilities, factories, homes and businesses of consumers. One or more of such devices may include one or more sensors that detect energy gain or loss, electrical input or output or loss, and a variety of other efficiencies. These sensors may collect data to inform users of how the energy pool, and individual devices within the pool, may be functioning and how they may be made more efficient. In a manufacturing environment, image data can be taken of the manufacturing process or other readings of manufacturing equipment. For example, in a semiconductor manufacturing environment, images can be used to track, for example, process points (e.g., movement from a bonding site to a packaging site), and process parameters (e.g., bonding force, electrical properties across a bond of an integrated circuit).

Network device sensors may also perform processing on data it collects before transmitting the data to a computing environment, or before deciding whether to transmit data to a computing environment. For example, network devices may determine whether data collected meets certain rules, for example by comparing data or values calculated from the data and comparing that data to one or more thresholds. The network device may use this data and/or comparisons to determine if the data should be transmitted to a computing environment for further use or processing.

Devices in computing environment 114 may include specialized computers, servers, or other machines that are configured to individually and/or collectively process large amounts of data (e.g., using a session pool 102). The computing environment 114 may also include storage devices (e.g., data stores 120) that include one or more databases of structured data, such as data organized in one or more hierarchies, or unstructured data. The databases may communicate with the processing devices within computing environment 114 to distribute data to them and store data used in the computing environment 114. Computing environment 114 may collect, analyze and/or store data from or pertaining to communications, client device operations, client rules, and/or user-associated actions stored at one or more devices in computing environment 114. Such data may influence communication routing to the devices within computing environment 114, and how data is stored or processed within computing environment 114, among other actions.

Network 100 may also include one or more network-attached data stores 120. Network-attached data stores 120 are used to store data to be processed by the computing environment 114 as well as any intermediate or final data generated by the computing system in non-volatile memory. For instance, data stores 120 can perform functions such as writing and copying data and can provide data storage for network functions such as sessions, authorization, publishing and retrieving packages. In certain embodiments, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated on-the-fly. In this non-limiting situation, the computing environment 114 may be configured to retain the processed information within memory so that responses can be generated for the user at different levels of detail as well as allow a user to interactively query against this information.

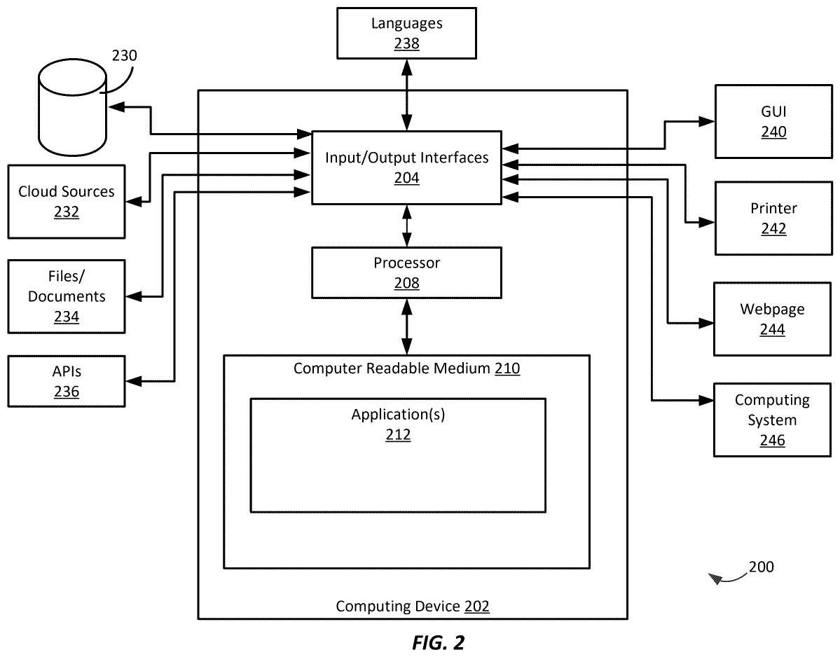

Network-attached data stores 120 may store a variety of different types of data organized in a variety of different ways and from a variety of different sources. For example, network-attached data stores 120 may include storage other than primary storage located within computing environment 114 that is directly accessible by processors located therein. Network-attached data stores 120 may include secondary, tertiary, auxiliary, or back-up storage (e.g., data storage 120B), such as large hard drives, servers, and virtual memory, among other types. Storage devices may include portable or non-portable storage devices, optical storage devices, and various other mediums capable of storing and containing data (e.g., computer a machine-readable storage medium or computer-readable storage medium such as computer readable medium 210 in FIG. 2).

Furthermore, the data stores may hold a variety of different types of data. For example, network-attached data stores 120 may hold unstructured (e.g., raw) data, such as manufacturing data (e.g., a database containing records identifying products being manufactured with parameter data for each product, such as performance metrics or criteria) or product sales databases (e.g., a database containing individual data records identifying details of individual product performance).

The unstructured data may be presented to the computing environment 114 in different forms such as a flat file or a conglomerate of data records and may have data values and accompanying time stamps. The computing environment 114 may be used to analyze the unstructured data in a variety of ways to determine the best way to structure (e.g., hierarchically) that data, such that the structured data is tailored to a type of further analysis on the data. For example, after being processed, the unstructured time stamped data may be aggregated by time (e.g., into daily time period units) to generate time series data and/or structured hierarchically according to one or more dimensions (e.g., parameters, attributes, and/or variables). For example, data may be stored in a hierarchical data structure, such as a ROLAP or MOLAP database, or may be stored in another tabular form, such as in a flat-hierarchy form.

Other devices can further be used to influence communication routing and/or processing between devices within computing environment 114 and with devices outside of computing environment 114. For example, as shown in FIG. 1, computing environment 114 may include a device 130 supporting a web application. Thus, computing environment 114 can retrieve data of interest, such as client information (e.g., product information, client rules, etc.), technical product details, news, current or predicted weather, and so on. Balancer 160 can be used to balance and direct load within the computing environment 114. Authentication device 150 can be used to provide authentication or other security protocols for a client device, user or group accessing computing environment 114.

In addition to computing environment 114 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices may receive data periodically from sensors as the sensors continuously sense, monitor and track changes in their environments. Devices within computing environment 114 may also perform pre-analysis on data it receives to determine if the data received should be processed as part of an ongoing project. The data received and collected by computing environment 114, no matter what the source or method or timing of receipt, may be processed over a period of time for a client to determine results data based on the client's needs and rules.

FIG. 1 includes a pool of devices with a pool manager 104 and session pool 102. Network 100 includes a variety of pool managers (e.g., pool manager 104) and worker nodes 110 (e.g., devices, servers, or server farms of session pool 102), according to embodiments of the present technology. Devices of session pool 102 are communicatively connected (e.g., via communication path 108 and communication path 106). Therefore, the pool manager may transmit information (e.g., related to the session pool 102 or notifications), to and receive information from each other. Although only one pool manager 104 is shown in FIG. 1, the network 100 may include more pool managers or a different kind of device manager (e.g., a dedicated resource manager).

Session pool 102 includes one or more worker nodes (e.g., worker node 110A). Shown in FIG. 1 are three worker nodes 110A-C merely for illustration, more or less worker nodes could be present. For instance, the pool manager 104 may itself be a worker node and may not need further worker nodes to complete a task. A given worker node could include dedicated computing resources or allocated computing resources as needed to perform operations as directed by the pool manager 104. The number of worker nodes included in a session pool 102 may be dependent, for example, upon how large the project or data set is being processed by the session pool 102, the capacity of each worker node, and the time designated for the session pool 102 to complete the project. Each worker node within the session pool 102 may be connected (wired or wirelessly, and directly or indirectly) to pool manager 104. Therefore, each worker node may receive information from the pool manager 104 (e.g., an instruction to perform work on a project) and may transmit information to the pool manager 104 (e.g., a result from work performed on a project). Furthermore, worker nodes 110 may communicate with each other (either directly or indirectly). For example, worker nodes 110 may transmit data between each other related to a job being performed or an individual task within a job being performed by that worker node. However, in certain embodiments, worker nodes 110 may not, for example, be connected (communicatively or otherwise) to certain other worker nodes. In an embodiment, worker nodes may only be able to communicate with the pool manager 104 that controls it and may not be able to communicate with other worker nodes in the session pool 102.

The pool manager 104 may connect with other devices of network 100 or an external device (e.g., a pool user, such as a server or computer). For example, a server or computer may connect to pool manager 104 and may transmit a project or job to the node. The project may include a data set. The data set may be of any size. Once the pool manager 104 receives such a project including a large data set, the pool manager 104 may distribute the data set or projects related to the data set to be performed by worker nodes 110. Alternatively, for a project including a large data set, the data set may be received or stored by a machine other than a pool manager 104 or worker node 110 (e.g., a Hadoop data node).

Pool manager may maintain knowledge of the status of the worker nodes 110 in the session pool 102 (i.e., status information), accept work requests from clients, subdivide the work across worker nodes 110, and coordinate the worker nodes 110, among other responsibilities. Worker nodes 110 may accept work requests from a pool manager 104 and provide the pool manager 104 with results of the work performed by the worker nodes 110. A session pool 102 may be started from a single node (e.g., a machine, computer, server, etc.). This first node may be assigned or may start as the primary pool manager 104 that will control any additional nodes that enter the session pool 102.

When a project is submitted for execution (e.g., by a client or a pool manager 104), it may be assigned to a set of nodes. After the nodes are assigned to a project, a data structure (i.e., a communicator) may be created. The communicator may be used by the project for information to be shared between the project code running on each node. A communication handle may be created on each node. A handle, for example, is a reference to the communicator that is valid within a single process on a single node, and the handle may be used when requesting communications between nodes.

A pool manager may be designated as the primary pool manager among multiple pool managers. A server, computer or other external device may connect to the primary pool manager. Once the pool manager receives a project, the primary pool manager may distribute portions of the project to its worker nodes for execution. For example, when a project is initiated on session pool 102, primary pool manager 104 controls the work to be performed for the project to complete the project as requested or instructed. The primary pool manager may distribute work to the worker nodes 110 based on various factors, such as which subsets or portions of projects may be completed most efficiently and in the correct amount of time. For example, a worker node may perform analysis on a portion of data that is already local (e.g., stored on) the worker node. The primary pool manager also coordinates and processes the results of the work performed by each worker node after each worker node executes and completes its job. For example, the primary pool manager may receive a result from one or more worker nodes, and the pool manager may organize (e.g., collect and assemble) the results received and compile them to produce a complete result for the project received from the end user.

Any remaining pool manager (not shown) may be assigned as backup pool manager for the project. In an embodiment, backup pool manager may not control any portion of the project. Instead, backup pool manager may serve as a backup for the primary pool manager and take over as primary pool manager if the primary pool manager were to fail.

To add another node or machine to the session pool 102, the primary pool manager may open a pair of listening sockets, for example. A socket may be used to accept work requests from clients, and the second socket may be used to accept connections from other pool nodes. The primary pool manager may be provided with a list of other nodes (e.g., other machines, computers, servers) that will participate in the pool, and the role that each node will fill in the pool. Upon startup of the primary pool manager (e.g., the first node on the pool), the primary pool manager may use a network protocol to start the server process on every other node in the session pool 102. Command line parameters, for example, may inform each node of one or more pieces of information, such as: the role that the node will have in the pool, the host name of the primary pool manager, and the port number on which the primary pool manager is accepting connections from peer nodes. The information may also be provided in a configuration file, transmitted over a secure shell tunnel, and recovered from a configuration server. While the other machines in the pool may not initially know about the configuration of the pool, that information may also be sent to each other node by the primary pool manager. Updates of the pool information may also be subsequently sent to those nodes.

For any pool manager other than the primary pool manager added to the pool, the pool manager may open multiple sockets. For example, the first socket may accept work requests from clients, the second socket may accept connections from other pool members, and the third socket may connect (e.g., permanently) to the primary pool manager. When a pool manager (e.g., primary pool manager) receives a connection from another pool manager, it first checks to see if the peer node is in the list of configured nodes in the pool. If it is not on the list, the pool manager may clear the connection. If it is on the list, it may then attempt to authenticate the connection. If authentication is successful, the authenticating node may transmit information to its peer, such as the port number on which a node is listening for connections, the host name of the node, and information about how to authenticate the node, among other information. When a node, such as the new pool manager, receives information about another active node, it will check to see if it already has a connection to that other node. If it does not have a connection to that node, it may then establish a connection to that pool manager.

Any worker node added to the pool may establish a connection to the primary pool manager and any other pool manager on the pool. After establishing the connection, it may authenticate itself to the pool (e.g., any pool manager, including both primary and backup, or a server or user controlling the pool). After successful authentication, the worker node may accept configuration information from the pool manager.

When a node joins a session pool 102 (e.g., when the node is powered on or connected to an existing node on the pool or both), the node is assigned (e.g., by an operating system of the pool) an identifier (e.g., a universally unique identifier (UUID)). This identifier may help other nodes and external entities (devices, users, etc.) to identify the node and distinguish it from other nodes. When a node is connected to the pool, the node may share its identifier with the other nodes in the pool. Since each node may share its identifier, each node may know the identifier of every other node on the pool. Identifiers may also designate a hierarchy of each of the nodes (e.g., backup pool manager) within the pool. For example, the identifiers of each of the backup pool manager may be stored in a list of backup pool manager to indicate an order in which the backup pool manager will take over for a failed primary pool manager to become a new primary pool manager. However, a hierarchy of nodes may also be determined using methods other than using the unique identifiers of the nodes. For example, the hierarchy may be predetermined or may be assigned based on other predetermined factors.

The pool may add new machines at any time (e.g., initiated from any pool manager). Upon adding a new node to the pool, the pool manager may first add the new node to its table of pool nodes. The pool manager may also then notify every other pool manager about the new node. The nodes receiving the notification may acknowledge that they have updated their configuration information.

Primary pool manager 104 may, for example, transmit one or more communications to backup pool manager or other control or worker nodes within the session pool 102). Such communications may be sent using protocols such as periodically, at fixed time intervals, or between known fixed stages of the project's execution. The communications transmitted by primary pool manager 104 may be of varied types and may include a variety of types of information. For example, primary pool manager 104 may transmit snapshots (e.g., status information) of the session pool 102 so that backup pool manager 104 always has a recent snapshot of the session pool 102. The snapshot or pool status may include, for example, the structure of the pool (including, for example, the worker nodes in the pool, unique identifiers of the nodes, or their relationships with the primary pool manager) and the status of a project (including, for example, the status of each worker node's portion of the project). The snapshot may also include analysis or results received from worker nodes in the session pool 102. The backup pool manager may receive and store the backup data received from the primary pool manager. The backup pool manager may transmit a request for such a snapshot (or other information) from the primary pool manager, or the primary pool manager may send such information periodically to the backup pool manager.

As noted, the backup data may allow the backup pool manager to take over as primary pool manager if the primary pool manager fails without requiring the pool to start the project over from scratch. If the primary pool manager fails, the backup pool manager that will take over as primary pool manager may retrieve the most recent version of the snapshot received from the primary pool manager and use the snapshot to continue the project from the stage of the project indicated by the backup data. This may prevent failure of the project as a whole.

A backup pool manager may use various methods to determine that the primary pool manager has failed. In one example of such a method, the primary pool manager may transmit (e.g., periodically) a communication to the backup pool manager that indicates that the primary pool manager is working and has not failed, such as a heartbeat communication. The backup pool manager may determine that the primary pool manager has failed if the backup pool manager has not received a heartbeat communication for a certain predetermined period of time. Alternatively, a backup pool manager may also receive a communication from the primary pool manager itself (before it failed) or from a worker node that the primary pool manager has failed, for example because the primary pool manager has failed to communicate with the worker node.

Different methods may be performed to determine which backup pool manager of a set of backup pool manager will take over for failed primary pool manager 104 and become the new primary pool manager. For example, the new primary pool manager may be chosen based on a ranking or “hierarchy” of backup pool manager based on their unique identifiers. In an alternative embodiment, a backup pool manager may be assigned to be the new primary pool manager by another device in the session pool 102 or from an external device (e.g., a system infrastructure or an end user, such as a server or computer, controlling the session pool 102). In another alternative embodiment, the backup pool manager that takes over as the new primary pool manager may be designated based on bandwidth or other statistics about the session pool 102.

A worker node within the session pool 102 may also fail. If a worker node fails, work being performed by the failed worker node may be redistributed amongst the operational worker nodes. In an alternative embodiment, the primary pool manager may transmit a communication to each of the operable worker nodes still on the session pool 102 that each of the worker nodes should purposefully fail also. After each of the worker nodes fail, they may each retrieve their most recent saved checkpoint of their status and re-start the project from that checkpoint to minimize lost progress on the project being executed.

While each device in FIG. 1 is shown as a single device, it will be appreciated that multiple devices may instead be used. FIG. 2 shows an example computing structure for a device in FIG. 2. FIG. 2 includes a computing device 202. The computing device 202 has a computer-readable medium 210 and a processor 208. Computer-readable medium 210 is an electronic holding place or storage for information so the information can be accessed by processor 208. The computer readable medium 210 is a non-transitory medium in which data can be stored and that does not include carrier waves and/or transitory electronic signals. Examples of a non-transitory medium may include, for example, a magnetic disk or tape, optical storage media such as compact disk or digital versatile disk, flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including, for example, memory sharing, message passing, token passing, and network transmission. Computer-readable medium 210 can include, but is not limited to, any type of random-access memory (RAM), any type of read only memory (ROM), any type of flash memory, etc. such as magnetic storage devices (e.g., hard disk, floppy disk, magnetic strips), optical disks (e.g., compact disc (CD), digital versatile disc (DVD)), smart cards, flash memory devices, etc.

Processor 208 executes instructions (e.g., stored at the computer-readable medium 210). The instructions can be carried out by a special purpose computer, logic circuits, or hardware circuits. In one or more embodiments, processor 208 is implemented in hardware and/or firmware. Processor 208 executes an instruction, meaning it performs or controls the operations called for by that instruction. The term “execution” is the process of running an application or the carrying out of the operation called for by an instruction. The instructions can be written using one or more programming language, scripting language, assembly language, etc. Processor 208 in one or more embodiments can retrieve a set of instructions from a permanent memory device and copy the instructions in an executable form to a temporary memory device that is generally some form of RAM, for example. Processor 208 operably couples with components of computing device 202 (e.g., input/output interface 204 and with computer readable medium 210) to receive, to send, and to process information.

For instance, in one or more embodiments, computing device 202 sends and/or receives information from one or more of databases 230, cloud sources 232, application programming interfaces 236 (API's), graphical user interfaces 240 (GUIs), printers 242, webpages 244, and computing systems 246. The input/output interface 204 may be configured to receive languages 238 (e.g., to communicate with other computing systems 246) or specific electronic files or documents 234 (e.g., inputs for building models or designing experiments). The input/output interface 204 may be a single interface (e.g., an output interface only to output reports to a printer 242), multiple interface (e.g., a graphical user interface 240 may be interactive and send and receive data over input/output interface 204), or a set of interfaces (e.g., to connect with multiple devices).

In one or more embodiments, computer-readable medium 210 stores instructions for execution by processor 208. In one or more embodiments, one or more applications stored on computer-readable medium 210 are implemented in software (e.g., computer-readable and/or computer-executable instructions) stored in computer-readable medium 210 and accessible by processor 208 for execution of the instructions.

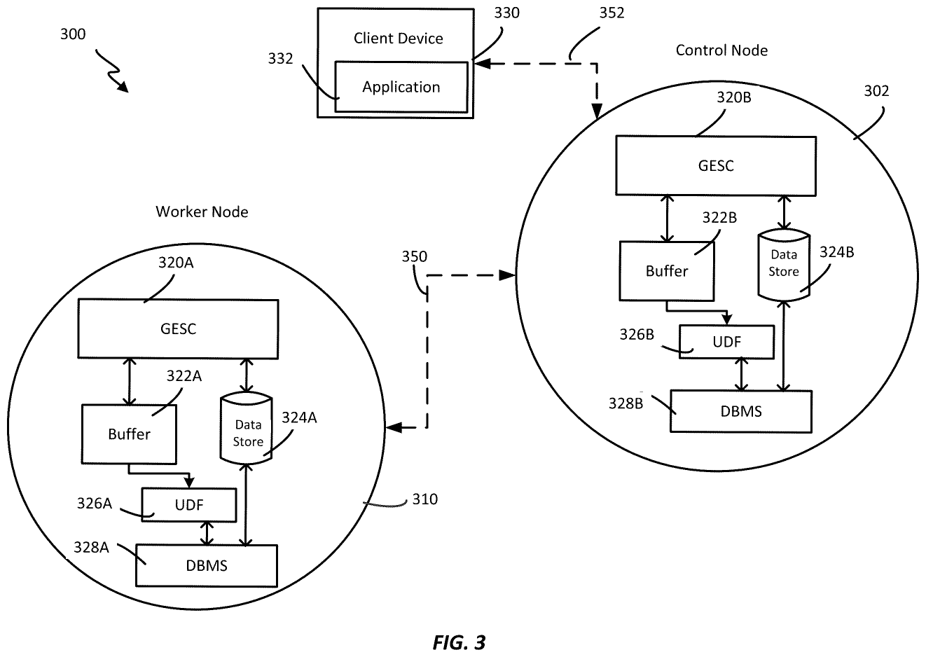

FIG. 3 illustrates a system 300 including a control node (e.g., pool manager 104 of FIG. 1) and a worker node (e.g., worker nodes 110 of FIG. 1), according to embodiments of the present technology. System 300 includes one control node (control node 302) and one worker node (worker node 310) for purposes of illustration but may include more worker and/or control node. The control node 302 is communicatively connected to worker node 310 via communication path 350. Therefore, control node 302 may transmit information (e.g., related to the session pool 102 or notifications), to and receive information from worker node 310 via path 350.

System 300 includes data processing nodes (e.g., control node 302 and worker node 310). Control node 302 and worker node 310 can include multi-core data processors. Each control node 302 and worker node 310 in this example includes a grid-enabled software component (GESC) 320 that executes on the data processor associated with that node and interfaces with buffer memory 322 also associated with that node. Each control node 302 and worker node 310 in this example includes a database management software (DBMS) 328 that executes on a database server (not shown) at control node 302 and on a database server (not shown) at worker node 310.

Each control node 302 and worker node 310 in this example also includes a data storage 324. Data storage 324, similar to network-attached data stores 120 in FIG. 1, are used to store data to be processed by the nodes in the computing environment. Data storage 324 may also store any intermediate or final data generated by the computing system after being processed, for example in non-volatile memory. However, in certain embodiments, the configuration of the system 300 allows its operations to be performed such that intermediate and final data results can be stored solely in volatile memory (e.g., RAM), without a requirement that intermediate or final data results be stored to non-volatile types of memory. Storing such data in volatile memory may be useful in certain situations, such as when the pool receives queries (e.g., ad hoc) from a client device 330 and when responses, which are generated by processing large amounts of data, need to be generated quickly or on-the-fly. In such a situation, the pool may be configured to retain the data within memory so that responses can be generated at different levels of detail and so that a client may interactively query against this information.

Each control node 302 and worker node 310 in this example also includes a user-defined function (UDF) 326. The UDF 326 provides a mechanism for the DBMS 328 to transfer data to or receive data from the database stored in the data storage 324 that are managed by the DBMS. For example, UDF 326 can be invoked by the DBMS 328 to provide data to the GESC 320 for processing. The UDF 326 may establish a socket connection (not shown) with the GESC 320 to transfer the data. Alternatively, the UDF 326 can transfer data to the GESC 320 by writing data to shared memory accessible by both the UDF 326 and the GESC 320.

The GESC 320 at the control node 302 and worker node 310 may be connected via a network. Therefore, control node 302 and worker node 310 can communicate with each other via the network using a predetermined communication protocol such as, for example, the Message Passing Interface (MPI). Each GESC 320 can engage in point-to-point communication with the GESC at another node or in collective communication with multiple GESCs via the network. The GESC 320 at each node may contain identical (or nearly identical) software instructions. Each control node 302 and worker node 310 may be configured to operate as either a pool manager or a worker node. The GESC 320B at the control node 302 can communicate, over a communication path 352, with a client device 330. More specifically, control node 302 may communicate with client application 332 hosted by the client device 330 to receive queries and to respond to those queries after processing large amounts of data.

DBMS 328 may control the creation, maintenance, and use of database or data structure (not shown) within control node 302 and worker node 310. The database may organize data stored in data storage 324. The DBMS 328 at control node 302 may accept requests for data and transfer the appropriate data for the request. With such a process, collections of data may be distributed across multiple physical locations. In this example, each control node 302 and worker node 310 stores a portion of the total data managed by the management system in its associated data storage 324.

Furthermore, the DBMS 328 may be responsible for protecting against data loss using replication techniques. Replication includes providing a backup copy of data stored on one node on one or more other nodes. Therefore, if one node fails, the data from the failed node can be recovered from a replicated copy residing at another node. Data or status information for each node in the session pool 102 may also be shared with each node on the pool.

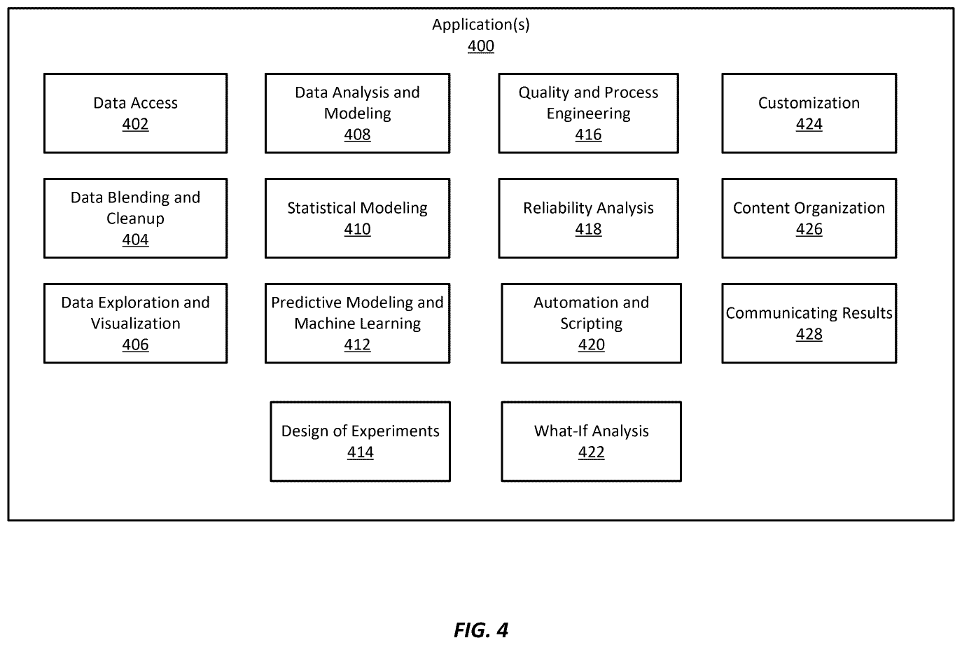

FIG. 4 provides example applications 400 (e.g., applications executed by a computing device 202, worker node 310, or control node 302) for performing one or more tasks or operations.

For example, data access operations 402 can be used for accessing data from different sources (e.g., importing and/or reading Excel files, flat files, relational databases, APIs, R, Python, and SAS® files and databases). For instance, data can be imported for data visualization, exploration and analysis. Data can be formatted or optimized. For instance, data blending and cleanup operations 404 can be used to remove complexity (e.g., in text, images and functions data) and for screening data (e.g., screening data for outliers, entry errors, missing values and other inconsistencies that can compromise data analysis). This can be useful for visual and interactive tools. Data can also be transformed, blended, grouped, filtered, merged into a single table or into subsets, or otherwise arranged for a particular scenario.

In one or more embodiments, one or more applications 400 include data exploration and visualization operations 406 that can be used to support plot and profiler tools. For instance, plot tools can be used to create data plots (e.g., to plot data to spot patterns and patterns that do not fit a trend). Some example plots include bubble plots, scatter plots (matrix and 3D), parallel plots, cell plots, contour plots, ternary plots, and surface plots. Profilers are tools that can be used to create a specialized set of plots in which changing one plot changes the other plots. For instance, profiling is an approach to generate visualizations of response surfaces by seeing what would happen if a user changed just one or two factors at a time. Profiler tools can be used to create interactive profiles of data (e.g., to explore and graph data dynamically and uncover hidden relationships between graphed data or interface with linked data, to interpret and understand the fit of equations to data, and to find factor values to optimize responses). Some example profiler tools include prediction profiler, contour profiler, surface profiler, mixture profiler, custom profiler, and excel profiler. A prediction profiler can be used to show vertical slices across each factor, holding other factors at a current value. A contour profiler allows horizontal slices showing contour lines for two factors at a time. A surface profiler generates three-dimensional plots for two factors at a time, or contour surface plot for 3 factors at a time. A mixture profiler is a contour profiler for mixture of factors. A custom profiler is a numerical optimizer. An excel profiler allows for visualization of models or formulas stored in electronic worksheets. Accordingly, profiler tools can allow for one or more of simulation, surface visualization, optimization, and desirability studies. Graphs (e.g., from plot or profiler tools) can be exported to electronic or print reports for presenting findings. Further, data exploration and visualization operations 406 can include text exploration such as computer extraction of symbols, characters, words and phrases; or computer visualization such as to organize symbols, characters, words and phrases to uncover information regarding a text or classify the text.

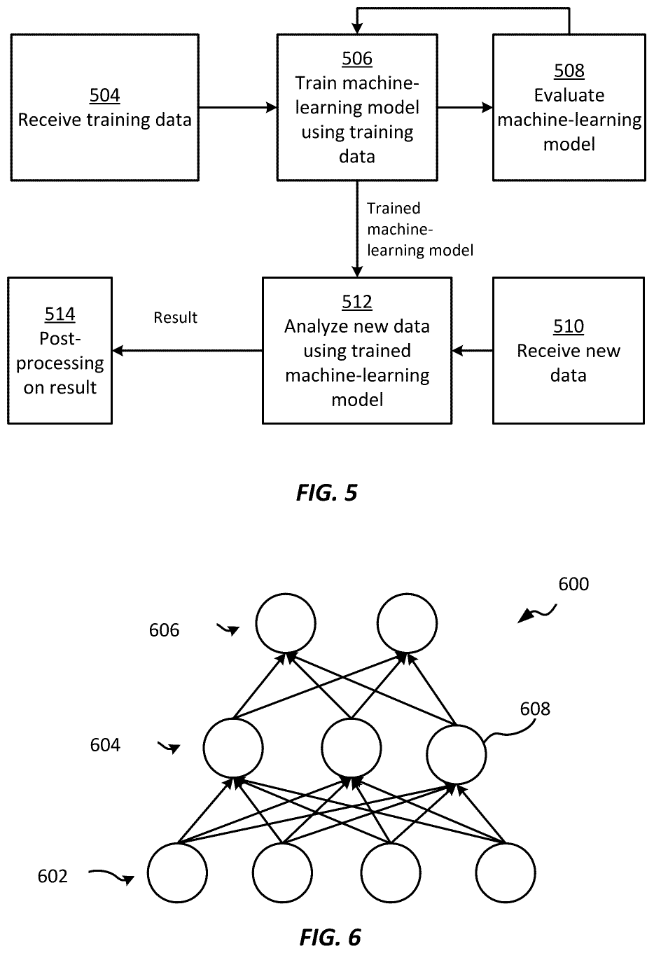

In one or more embodiments, one or more applications 400 include data analysis and modeling operations 408 can be used to analyze one or many variables or factors in linked analysis. Analysis results may be linked with specific graphs designed for different types of data or metrics (e.g., graphs related to histograms, regression modeling and distribution fitting). Data analysis and modeling can be performed real-time (or just-in-time). For instance, applications 400 can include statistical modeling operations 410. For instance, statistical modeling operations 410 can be used for a diversity of modeling tasks such as univariate, multivariate and multifactor. Data can be transformed from its collected form (e.g., text or functional form) and data can be used for building models for better insights (e.g., discovery trends or patterns in data). As another example, one or more applications 400 can include predictive modeling and machine learning operations 412 to build models using predictive modeling techniques, such as regression, neural networks and decision trees. The operations 412 can be used to fit multiple predictive models and determine the best performing model with model screening. Validation (e.g., cross-validation and k-fold cross-validation) can be used (e.g., to prevent over-fitting or to select a best model). Machine learning methods can be used by the user without having to write code and tune algorithms. Examples of machine learning techniques are described in more detail with respect to FIGS. 5 and 6).

In one or more embodiments, one or more applications 400 include design of experiments (DOE) operations 414 used to create designs for experiments that provide test conditions for one or more factors tested in the experiment. For example, the design of experiments operations 414 can be used to create optimally designed experiments, efficient experiments to meet constraints, process limitations and budget, and/or screening designs to untangle important effects between multiple factors. DOE operations 414 can also be used for evaluating designs (e.g., design diagnostic measures such as efficiency metrics).

In one or more embodiments, one or more applications 400 include quality and process engineering operations 416 to track and visualize quality and processes. For instance, the quality and process engineering operations 416 can generate charts to explore root causes of quality or process problems (e.g., causes of variation in manufacturing processes and drill down into problem processes). Additionally, or alternatively, they can be used to generate notifications for metrics that exceed a threshold such as an out-of-control signal or a control chart warning. Additionally, or alternatively, they can be used to study the capability and performance of one or more variables to identify processes that are not meeting user-defined goals. Objective data from processes or consumer data can be used to release better products and react to market trends.

In one or more embodiments, one or more applications 400 include reliability analysis operations 418. For example, in manufacturing, reliability analysis tools can be used to prevent failure, improve warranty or product performance, find and address important design vulnerabilities, and pinpoint defects in materials or processes. Reliability analysis tools can also be used to determine how to reduce or improve these issues (e.g., by identifying trends and outliers in data and model predictions). What-if Analysis operations 422 can be used to demonstrate patterns of predicted responses and the effect of each factor on the response with scenario analysis. For example, a graphical user interface can be used for a user to put in different inputs, assumptions or constraints for a system and observe responses or effects. For instance, in a measurement system analysis analyzing whether parts would be in-specification, different estimated variances between parts and operators testing the parts could be varied to determine the effect on modeled output for the measurement system analysis.

In one or more embodiments, one or more applications 400 include automation and scripting operations 420. For example, automation can allow code-free access for a user to automation routines all the way up to completely customized applications (e.g., code free access to SAS®, MATLAB®, Python® and R routines). For example, a design created for experiments can be automated such that automatic testing is performed for the design.

In one or more embodiments, one or more applications 400 include operations for greater user control and interaction. For instance, customization operations 424 can be used for user customization (e.g., mass customizations, and customizations of graphics, statistics, and default views). As another example, content organization operations 426 can be used to organize data (e.g., translate statistical results to a simplified view to communicate findings and organize, summarize, and document content to better aid the accountability and reproducibility of projects). As another example, the communicating results operations 428 can be used for presentation of results, models, or other output from one or more applications 400 (e.g., presented in print, graphical user interface, or web-based versions).

In one or more embodiments, fewer, different, and additional components can be incorporated into computing device 202. In one or more embodiments, the input/output interface has more than one interface that uses the same or different interface technology.

In one or more embodiments, the one or more applications 400 can be integrated with other analytic or computing tools not specifically shown here. For instance, one or more applications are implemented using or integrated with one or more software tools such as JMP®, Base SAS, SAS® Enterprise Miner™, SAS/STAT®, SAS® High Performance Analytics Server, SAS® Visual Data Mining and Machine Learning, SAS® LASR™ SAS® In-Database Products, SAS® Scalable Performance Data Engine, SAS® Cloud Analytic Services, SAS/OR®, SAS/ETS®, SAS® Inventory Optimization, SAS® Inventory Optimization Workbench, SAS® Visual Analytics, SAS® Viya™, SAS In-Memory Statistics for Hadoop®, SAS® Forecast Server, and SAS/IML®.

One or more embodiments are useful for generating and using machine-learning models. FIG. 5 is a flow chart of an example of a process for generating and using a machine-learning model according to some aspects. Machine learning is a branch of artificial intelligence that relates to mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector operator (LASSO) classifiers, and support vector machines; (iv) clusterers, such as k-means clustering, mean-shift clusterers, and spectral clusterers; (v) factorizers, such as factorization machines, principal component analyzers and kernel principal component analyzers; and (vi) ensembles or other combinations of machine-learning models. In some examples, neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, transformer networks, large language models (LLMs), LLM agents, or any combination of these.

Different machine-learning models may be used interchangeably to perform a task. Examples of tasks that can be performed at least partially using machine-learning models include various types of scoring; bioinformatics; cheminformatics; software engineering; fraud detection; customer segmentation; generating online recommendations; adaptive websites; determining customer lifetime value; search engines; placing advertisements in real time or near real time; classifying DNA sequences; affective computing; performing natural language processing and understanding; object recognition and computer vision; robotic locomotion; playing games; optimization and metaheuristics; detecting network intrusions; medical diagnosis and monitoring; or predicting when an asset, such as a machine, will need maintenance.

Any number and combination of tools can be used to create machine-learning models. Examples of tools for creating and managing machine-learning models can include SAS® Enterprise Miner, SAS® Rapid Predictive Modeler, and SAS® Model Manager, SAS Cloud Analytic Services (CAS)®, SAS Viya® of all which are by SAS Institute Inc. of Cary, North Carolina.

Machine-learning models construction can be at least partially automated (e.g., with little or no human involvement) in a training process. During training, input data can be iteratively supplied to a machine-learning model to enable the machine-learning model to identify patterns related to the input data or to identify relationships between the input data and output data. With training, the machine-learning model can be transformed from an untrained state to a trained state. Input data can be split into one or more training sets and one or more validation sets, and the training process may be repeated multiple times. The splitting may follow a k-fold cross-validation rule, a leave-one-out-rule, a leave-p-out rule, or a holdout rule. An overview of training and using a machine-learning model is described below with respect to the flow chart of FIG. 5.

In block 504, training data is received. In some examples, the training data is received from a remote database or a local database, constructed from various subsets of data, or input by a user. The training data can be used in its raw form for training a machine-learning model or pre-processed into another form, which can then be used for training the machine-learning model. For example, the raw form of the training data can be smoothed, truncated, aggregated, clustered, or otherwise manipulated into another form, which can then be used for training the machine-learning model.

In block 506, a machine-learning model is trained using the training data. The machine-learning model can be trained in a supervised, unsupervised, or semi-supervised manner. In supervised training, each input in the training data is correlated to a desired output. This desired output may be a scalar, a vector, or a different type of data structure such as text or an image. This may enable the machine-learning model to learn a mapping between the inputs and desired outputs. In unsupervised training, the training data includes inputs, but not desired outputs, so that the machine-learning model has to find structure in the inputs on its own. In semi-supervised training, only some of the inputs in the training data are correlated to desired outputs.

In block 508, the machine-learning model is evaluated. For example, an evaluation dataset can be obtained, for example, via user input or from a database. The evaluation dataset can include inputs correlated to desired outputs. The inputs can be provided to the machine-learning model and the outputs from the machine-learning model can be compared to the desired outputs. If the outputs from the machine-learning model closely correspond with the desired outputs, the machine-learning model may have a high degree of accuracy. For example, if 90% or more of the outputs from the machine-learning model are the same as the desired outputs in the evaluation dataset, the machine-learning model may have a high degree of accuracy. Otherwise, the machine-learning model may have a low degree of accuracy. The 90% number is an example only. A realistic and desirable accuracy percentage is dependent on the problem and the data.

In some examples, if the machine-learning model has an inadequate degree of accuracy for a particular task, the process can return to block 506, where the machine-learning model can be further trained using additional training data or otherwise modified to improve accuracy. If the machine-learning model has an adequate degree of accuracy for the particular task, the process can continue to block 510.

In block 510, new data is received. In some examples, the new data is received from a remote database or a local database, constructed from various subsets of data, or input by a user. The new data may be unknown to the machine-learning model. For example, the machine-learning model may not have previously processed or analyzed the new data.

In block 512, the trained machine-learning model is used to analyze the new data and provide a result. For example, the new data can be provided as input to the trained machine-learning model. The trained machine-learning model can analyze the new data and provide a result that includes a classification of the new data into a particular class, a clustering of the new data into a particular group, a prediction based on the new data, or any combination of these.

In block 514, the result is post-processed. For example, the result can be added to, multiplied with, or otherwise combined with other data as part of a job. As another example, the result can be transformed from a first format, such as a time series format, into another format, such as a count series format. Any number and combination of operations can be performed on the result during post-processing.

A more specific example of a machine-learning model is the neural network 600 shown in FIG. 6. The neural network 600 is represented as multiple layers of interconnected neurons, such as neuron 608, that can exchange data between one another. The layers include an input layer 602 for receiving input data, a hidden layer 604, and an output layer 606 for providing a result. The hidden layer 604 is referred to as hidden because it may not be directly observable or have its input directly accessible during the normal functioning of the neural network 600. Although the neural network 600 is shown as having a specific number of layers and neurons for exemplary purposes, the neural network 600 can have any number and combination of layers, and each layer can have any number and combination of neurons.

The neurons and connections between the neurons can have numeric weights, which can be tuned during training. For example, training data can be provided to the input layer 602 of the neural network 600, and the neural network 600 can use the training data to tune one or more numeric weights of the neural network 600. In some examples, the neural network 600 can be trained using backpropagation.

Backpropagation can include determining a gradient of a particular numeric weight based on a difference between an actual output of the neural network 600 and a desired output of the neural network 600. Based on the gradient, one or more numeric weights of the neural network 600 can be updated to reduce the difference, thereby increasing the accuracy of the neural network 600. This process can be repeated multiple times to train the neural network 600. For example, this process can be repeated hundreds or thousands of times to train the neural network 600.

In some examples, the neural network 600 is a feed-forward neural network. In a feed-forward neural network, every neuron only propagates an output value to a subsequent layer of the neural network 600. For example, data may only move one direction (forward) from one neuron to the next neuron in a feed-forward neural network.

In other examples, the neural network 600 is a recurrent neural network. A recurrent neural network can include one or more feedback loops, allowing data to propagate in both forward and backward through the neural network 600. This can allow for information to persist within the recurrent neural network. For example, a recurrent neural network can determine an output based at least partially on information that the recurrent neural network has seen before, giving the recurrent neural network the ability to use previous input to inform the output.

In some examples, the neural network 600 operates by receiving a vector of numbers from one layer; transforming the vector of numbers into a new vector of numbers using a matrix of numeric weights, a nonlinearity, or both; and providing the new vector of numbers to a subsequent layer of the neural network 600. Each subsequent layer of the neural network 600 can repeat this process until the neural network 600 outputs a final result at the output layer 606. For example, the neural network 600 can receive a vector of numbers as an input at the input layer 602. The neural network 600 can multiply the vector of numbers by a matrix of numeric weights to determine a weighted vector. The matrix of numeric weights can be tuned during the training of the neural network 600. The neural network 600 can transform the weighted vector using a nonlinearity, such as a sigmoid tangent or the hyperbolic tangent. In some examples, the nonlinearity can include a rectified linear unit, which can be expressed using the following equation:

y=max(x,0)

where y is the output and x is an input value from the weighted vector. The transformed output can be supplied to a subsequent layer, such as the hidden layer 604, of the neural network 600. The subsequent layer of the neural network 600 can receive the transformed output, multiply the transformed output by a matrix of numeric weights and a nonlinearity, and provide the result to yet another layer of the neural network 600. This process continues until the neural network 600 outputs a final result at the output layer 606.

Other examples of the present disclosure may include any number and combination of machine-learning models having any number and combination of characteristics. The machine-learning model(s) can be trained in a supervised, semi-supervised, or unsupervised manner, or any combination of these. The machine-learning model(s) can be implemented using a single computing device or multiple computing devices, such as the session pool 102 discussed above.

Implementing some examples of the present disclosure at least in part by using machine-learning models can reduce the total number of processing iterations, time, memory, electrical power, or any combination of these consumed by a computing device when analyzing data. For example, a neural network may more readily identify patterns in data than other approaches. This may enable the neural network and/or a transformer model to analyze the data using fewer processing cycles and less memory than other approaches, while obtaining a similar or greater level of accuracy.

Some machine-learning approaches may be more efficiently and speedily executed and processed with machine-learning specific processors (e.g., not a generic CPU). Such processors may also provide an energy savings when compared to generic CPUs. For example, some of these processors can include a graphical processing unit (GPU), an application-specific integrated circuit (ASIC), a field-programmable gate array (FPGA), an artificial intelligence (AI) accelerator, a neural computing core, a neural computing engine, a neural processing unit, a purpose-built chip architecture for deep learning, and/or some other machine-learning specific processor that implements a machine learning approach or one or more neural networks using semiconductor (e.g., silicon (Si), gallium arsenide (GaAs)) devices. These processors may also be employed in heterogeneous computing architectures with a number of and/or a variety of different types of cores, engines, nodes, and/or layers to achieve various energy efficiencies, processing speed improvements, data communication speed improvements, and/or data efficiency targets and improvements throughout various parts of the system when compared to a homogeneous computing architecture that employs CPUs for general purpose computing.

One or more embodiments are useful for improving computer-predictions (e.g., predictions related to identifying likely causes for outcomes of an experiment or model of an experiment). In designing experiments for a system, engineers can specify factors that can lead to an outcome in the experiment. The system can then be tested in the experiment by specifying levels or inputs for the factors and recording the outcome in response. In some embodiments, it is possible, rather than conducting a full experiment itself, to use a model. A model can predict and extrapolate to other data points from a limited number of data points collected (e.g., from a limited experiment). Experiments, or models of an experiment (e.g., a machine learning model or computer-generated model), can be used to make a discovery about a system, test a theory about a system, or test or explore a model of the system. In some cases, it can be useful to identify what combination of factors led to an outcome that occurred during the experiment or execution of an experiment model.

Traditional approaches to identifying combinations that lead to an outcome included a sequential approach in which more testing is performed for factor inputs that experienced a particular outcome. In a sequential approach, test cases are designed for these inputs to sequentially test combination of these inputs that could explain a failure indication. However, there could be billions of possible test cases to test every possible combination associated with a particular outcome to determinatively identify the particular combination or combinations that lead to that outcome. When considering multiple factors, the number of possible combinations of levels and/or factors becomes quickly difficult to manage for determining a cause of an outcome. Further, it may not be feasible in many circumstances to test billions of test cases. For instance, an airplane system could have hundreds of factors that could influence the airplane's ability to meet some performance criteria such as take-off speed or sensor detection. It could be expensive to test even a single test case and time consuming to design and implement the environment for the test case. As another example, there could be a limited ability to supply the input for further testing. For instance, if the tested system involves failure in medical equipment there could be a limited amount of supply of biological information for the medical equipment (e.g., limited amount of blood for testing of a blood analyzer).

Embodiments improve traditional methodologies for identifying combinations involved in an outcome (e.g., sequential approaches) by providing tools for predicting the most likely factors that lead to an outcome. For instance, one or more embodiments improve traditional approaches to predicting factors that lead to an outcome by providing improved methods for locating factors and evaluating factors. That can reduce the debugging costs and increase success of finding the correct combination. For instance, in a software context, it could reduce the software development life cycle. In situations with a limited quantity of additional test cases, it is possible with sequential approaches that the correct combination would not be identified within the additional test cases. Embodiments provide a targeted approach that can identify a correct combination in a smaller amount of test cases than traditional sequential approaches.

One or more embodiments provide improved computing systems and graphical user interfaces for receiving and utilizing domain knowledge or structural knowledge in determining an informed ranking and for limiting computations for determining that informed ranking. For instance, an expert could have analyzed computer code to determine likely causes or studied outcomes in previous experiments. Where there is a large quantity of factors, the traditional approaches involved blind testing (e.g., sequential approaches). Blind testing is especially difficult to implement in highly complex systems where there would need to be many test cases implemented and the test cases could be processing or financially costly to implement. However, complex systems make it difficult to identify important factors for debugging. Embodiments enable the quantification and specification of prior knowledge or expert opinions, which is useful for constructing prior distributions for a Bayesian analysis of outcomes (e.g., failures in a test suite). This can encourage debugging even when there is a large quantity of factors. Debugging can include, for instance, investigation into the computer code to gain more targeted knowledge that can now be utilized by computing systems according to embodiments.

Embodiments also allow for graphical user interface and computing systems for utilization of processing constraints, which can reduce test cases and processing time. For instance, embodiments enable a user to input a custom processing constraint in a graphical user interface, which can limit test cases and/or processing time. Further, the processing constraints can be flexibly applied to quickly see in a graphical user interface if more test cases would increase the likelihood of discovering a combination that led to an outcome using a target approach.

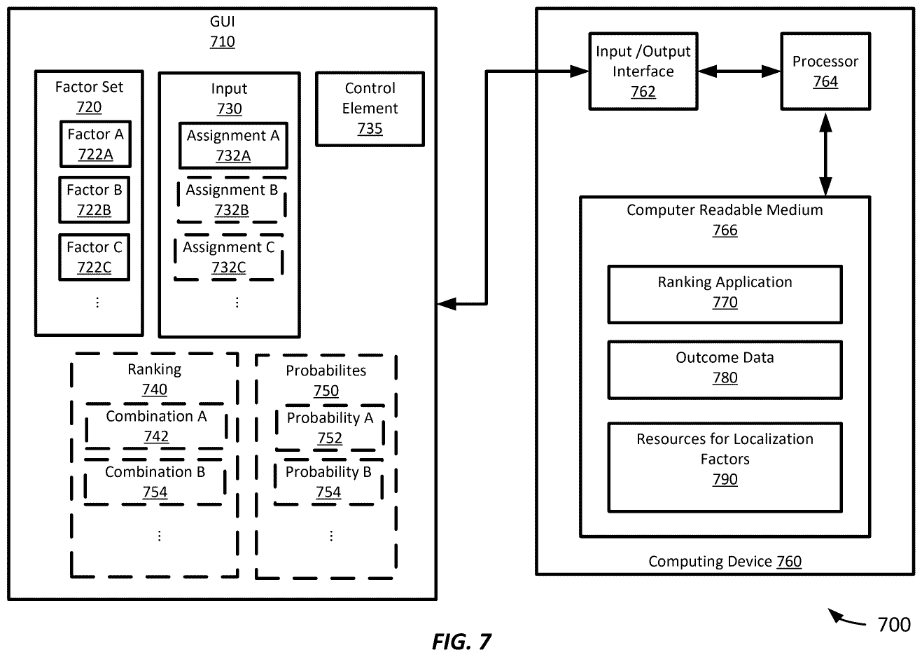

FIG. 7 illustrates a block diagram of a system 700 for generating computer-generated predictions for factor(s) contributing to an outcome (e.g., using a targeted approach). System 700 includes a computing device 760 and a graphical user interface 710. In one or more embodiments, the system 700 includes one or more input and/or output devices for receiving or sending information (e.g., to or from graphical user interface 710). Alternatively, or additionally, the computing device 760 is a device with a display for displaying graphical user interface 710. For example, a tablet is a device that receives and sends information (e.g., to and from graphical user interface 710).

In one or more embodiments, graphical user interface 710 a factor set 720 of multiple factors for an experiment. Alternatively, or additionally, the graphical user interface has an input element 730 for receiving an assignment 732A to at least one factor (e.g., factor 722A) or at least one combination of factors from the factor set 720 (e.g., factor 722A and factor 722B). Assignment(s) 732 can incorporate domain knowledge or expert opinions to construct suitable prior distributions for a Bayesian analysis of outcomes (e.g., failures in a test suite). Embodiments incorporate prior knowledge (which may include code analysis) into the fault localization process. Embodiments address challenges with quantify and specify that prior knowledge. For instance, the assignment can indicate an estimation as to a contribution of a recipient of the assignment to an estimated outcome for the experiment (e.g., a particular level or factor is likely to be a cause for failure). The user can have prior knowledge about system components that they want to quantify using the input element. Alternatively, or additionally, the graphical user interface 710 includes a control element 735 for controlling an extent of computational processing for the factor set 720. Even with assignments, there may still be a number of computation combinations to explore that could take days to compute without limiting the computation processing. Control element 735 in embodiments allows for a user to interact with computing device 760 and limit the extent of computation processing (e.g., limiting the number of factors and combination of factors explored or limiting the time spent on processing).

The system 700 is configured to exchange information between devices in the system (e.g., via wired and/or wireless transmission). For example, a network (not shown) can connect one or more devices of system 700 to one or more other devices of system 700. Alternatively, or additionally, the system is integrated into one device (e.g., a touch screen for entry and display in graphical user interface 710). For instance, the computing device 760 can receive an indication of an authorized extent of computational processing controlled using the control element 735 (e.g., via input and/or output interface 762). Alternatively, or additionally, the computing system can receive assignment(s) 732 via the input element 730 of the graphical user interface 710.

The computing device 760 has a computer-readable medium 766 and a processor 764. Computer-readable medium 766 is an electronic holding place or storage for information so the information can be accessed by processor 764. Computer-readable medium 766 can include, but is not limited to, any type of random access memory (RAM), any type of read only memory (ROM), any type of flash memory, etc. such as magnetic storage devices (e.g., hard disk, floppy disk, magnetic strips), optical disks (e.g., compact disc (CD), digital versatile disc (DVD)), smart cards, flash memory devices, etc.

For instance, in one or more embodiments, computer-readable medium 766 has, stores, and/or dynamically allocates resources available to the computer device 760 or the system 700 (e.g., in computer-readable medium 766). For instance, based on the indication of the authorized extent of computational processing, the computing device 760 can dynamically allocate resources 790 for generating a set of localization factors. The set of localization factors are for localizing one or more of the factor set 720 influencing a given outcome for the experiment or an experiment model for the experiment. Alternatively, or additionally, the computing system can obtain outcome data 780 that is based on conducting an experiment or executing an experiment model. For example, the input and/or output interface 762 can be used to receive outcome data 780 from another device (not shown) in system 700. For instance, outcome data 780 can be recorded from sensor devices sensing a system such as camera, temperature sensors, pressures sensors, etc. observing a manufacturing environment. Outcome data 780 can indicate one or more outcomes from conducting the experiment or executing the experiment model. For instance, potential outcomes could include a failure or a success outcome, and/or potential outcomes could include different processing times in the manufacturing environment. Alternatively, or additionally, input and/or output interface 762 can receive a selection made in graphical user interface 710 to identify outcome data already stored or generated at computing device 760.

In one or more embodiments, processor 764 executes instructions (e.g., stored at the computer-readable medium 766). The instructions can be carried out by a special purpose computer, logic circuits, or hardware circuits. In one or more embodiments, processor 764 is implemented in hardware and/or firmware. Processor 764 executes an instruction, meaning it performs or controls the operations called for by that instruction. The term “execution” is the process of running an application or the carrying out of the operation called for by an instruction. The instructions can be written using one or more programming language, scripting language, assembly language, etc. Processor 764 in one or more embodiments can retrieve a set of instructions from a permanent memory device and copy the instructions in an executable form to a temporary memory device that is generally some form of RAM, for example. Processor 764 operably couples with components of computing device 760 (e.g., input and/or output interface 762, and with computer-readable medium 766) to receive, to send, and to process information.

For example, in one or more embodiments, the computer-readable medium 766 comprises instructions for a ranking application 770. The ranking application 770 can be used to generate a ranking 740 of factors from factor set 720 and/or combination of factors. For instance, the ranking application can generate the ranking, based on the outcome data 780, the indication of the authorized extent of computational processing by the control element 735, and/or assignment(s) 732. For example, ranking 740 can include a first combination of factors 742 and a second combination of factors 754 from the set of localization factors. The first combination of factors 742 and the second combination of factors 754 are different. The ranking 740 can indicate a computer-generated model of a contribution of the set of localization factors to a given outcome of the at least two outcomes. Alternatively, or additionally, the ranking application 770 can generate probabilities 750 indicating a probability or likelihood that a given combination contributed to a given outcome of the outcome data 780. In one or more embodiments, the ranking application 770 controls the graphical user interface 710 to display computer-generated predictions for the outcome data 780 (e.g., ranking 740 and/or probabilities 750).

In one or more embodiments, one or more applications stored in computer-readable medium 766 are implemented in software (e.g., computer-readable and/or computer-executable instructions) stored in computer-readable medium 766 and accessible by processor 764 for execution of the instructions. The one or more application can be integrated with other analytic tools. As an example, the ranking application 770 is integrated with data analytics software application and/or software architecture such as that offered by SAS Institute Inc. or JMP Statistical Discovery LLC of Cary, N.C., USA. Merely for illustration, the applications are implemented using or integrated with one or more SAS software tools such as JMP®, Base SAS, SAS® Enterprise Miner™, SAS/STAT®, SAS® High Performance Analytics Server, SAS® Visual Data Mining and Machine Learning, SAS® LASR™ SAS® In-Database Products, SAS® Scalable Performance Data Engine, SAS® Cloud Analytic Services, SAS/OR®, SAS/ETS®, SAS® Inventory Optimization, SAS® Inventory Optimization Workbench, SAS® Visual Analytics, SAS® Viya™, SAS In-Memory Statistics for Hadoop®, SAS® Forecast Server, and SAS/IML®.

One or more applications stored on computer-readable medium 766 can be implemented as a Web application. For example, an application can be configured to receive hypertext transport protocol (HTTP) responses and to send HTTP requests. The HTTP responses may include web pages such as hypertext markup language (HTML) documents and linked objects generated in response to the HTTP requests. Each web page may be identified by a uniform resource locator (URL) that includes the location or address of the computing device that contains the resource to be accessed in addition to the location of the resource on that computing device. The type of file or resource depends on the Internet application protocol such as the file transfer protocol, HTTP, H.323, etc. The file accessed may be a simple text file, an image file, an audio file, a video file, an executable, a common gateway interface application, a Java applet, an extensible markup language (XML) file, or any other type of file supported by HTTP.

In one or more embodiments, fewer, different, and additional components can be incorporated into computing device 760, graphical user interface 710, and/or system 700. For instance, in one or more embodiments, there are multiple input devices or computing systems communicating with computing device 760 (e.g., for obtaining outcome data 780). As another example, computing device 760 includes multiple interfaces that use the same or different interface technology.

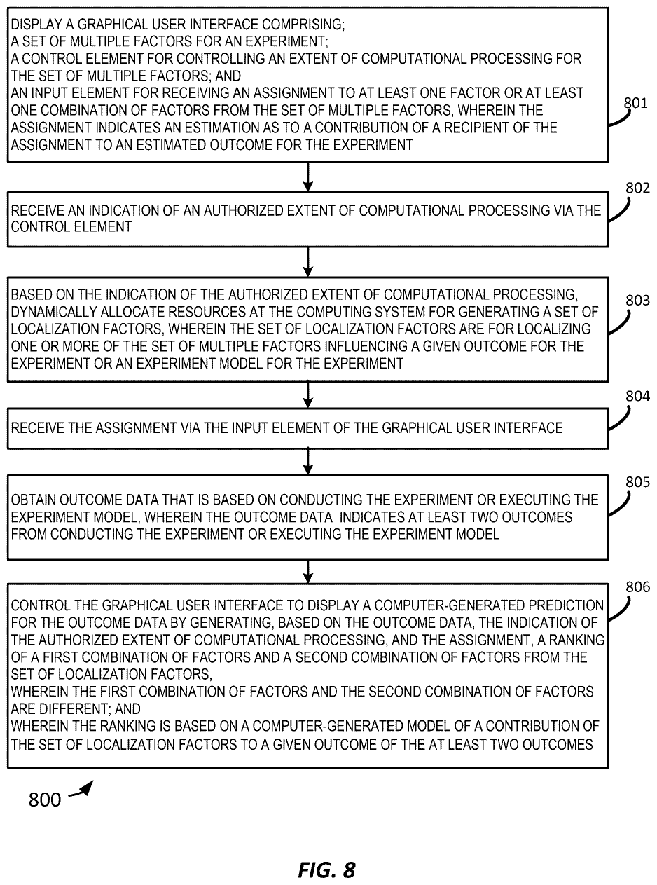

In one or more embodiments, the system 700 implements a method as described herein (e.g., a method shown in FIG. 8). FIG. 8 illustrates a flow diagram of a method 800 for displaying computer-generated predictions for factor(s) contributing to an outcome. For example, the method 800 can be implemented by a computing system (e.g., system 700 and/or computing device 760).

The method 800 includes an operation 801 that includes displaying a graphical user interface (e.g., graphical user interface 710). The graphical user interface includes, for example, a set of multiple factors for an experiment (e.g., factor set 720). Alternatively, or additionally, the graphical user interface includes a control element for controlling an extent of computational processing for the set of multiple factors (e.g., control element 735). Alternatively, or additionally, the graphical user interface includes an input element for receiving an assignment to at least one factor or at least one combination of factors from the set of multiple factors (e.g., input element 730). The assignment indicates an estimation as to a contribution of a recipient of the assignment to an estimated outcome for the experiment.

The method 800 includes an operation 802 that includes receiving an indication of an authorized extent of computational processing via the control element. For example, this indication could limit how many factors or combinations of factors are explored to localize a fault of an outcome and/or how much time is spent exploring factors or combinations of factors. Embodiments enable computer-generated predictions for factor(s) contributing to an outcome even in constrained processing environments.

The method 800 includes an operation 803 that includes, based on the indication of the authorized extent of computational processing, dynamically allocating resources at the computing system for generating a set of localization factors. The set of localization factors are for localizing one or more of the multiple factors influencing a given outcome for the experiment or an experiment model for the experiment. Embodiments provide a targeted approach for exploration of factors as candidates for outcome explanation.

The method 800 includes an operation 804 for receiving the assignment via the input element of the graphical user interface. Assignments can quantify domain or structural knowledge which can inform a targeted analysis of evaluating factors.

The method 800 includes an operation 805 for obtaining outcome data that is based on conducting the experiment or executing the experiment model. The outcome data indicates at least two outcomes from conducting the experiment or executing the experiment model. For example, the outcomes could be success and failure. In another example, the outcomes could include different malfunction criteria (e.g., failure during a certain period of time, or had certain ranges of performance).

The method 800 includes an operation 806 for controlling the graphical user interface to display a computer-generated prediction for the outcome data by generating, based on the outcome data, the indication of the authorized extent of computational processing, and the assignment, a ranking of a first combination of factors and a second combination of factors from the set of localization factors. The first combination of factors and the second combination of factors are different. The ranking is based on a computer-generated model of a contribution of the set of localization factors to a given outcome of the at least two outcomes. The ranking could also include individual factors and/or additional combinations of factors. The ranking can be useful at enabling targeted follow-up testing for confirming computer-generated predictions.

One or more operations of method 800 can be repeated to update the computer-generated prediction. For instance, operation 804 can be repeated to receive an updated assignment for the at least one factor or the at least one combination of factors, and the prediction will update responsive to the updated assignment (e.g., updating the ranking displayed in a graphical user interface). This can be useful as more information is received (e.g., from debugging efforts).

Alternatively, or additionally, operation 802 can be repeated to receive a different indication of an authorized extent of computational processing and a prediction can update responsive to the updated indication. For instance, the indication can indicate to explore a small, medium, or large quantity of covers where covers in this context are explored factors or combinations of factors. Embodiments enable quickly seeing if more test cases would increase the likelihood of discovering a combination that led to an outcome (e.g., if the computer-predictions indicate different likelihoods for factor causes according to different authorized extents of computational processing).

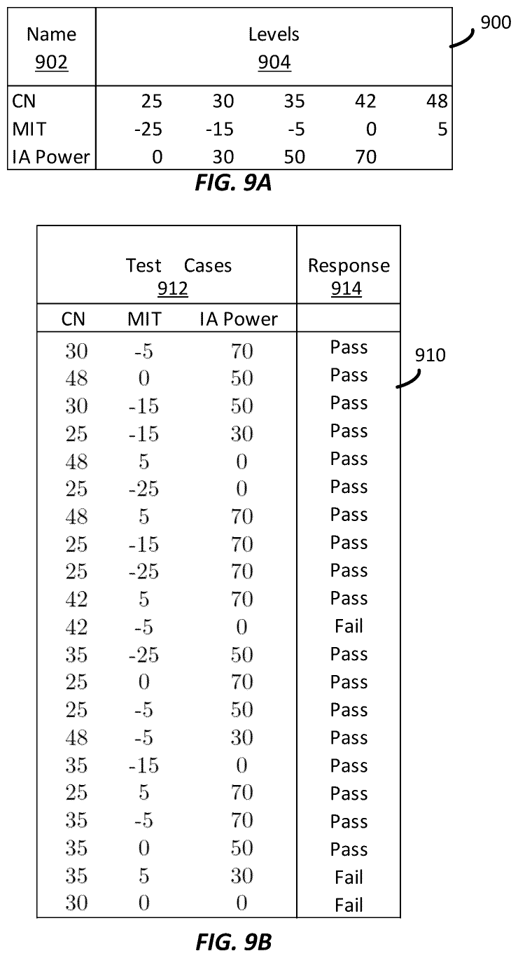

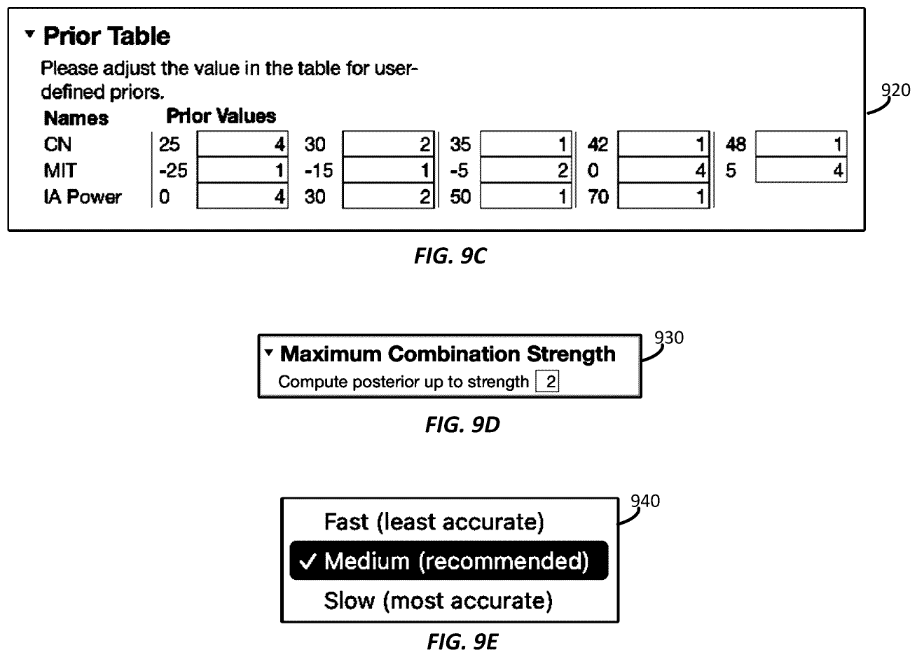

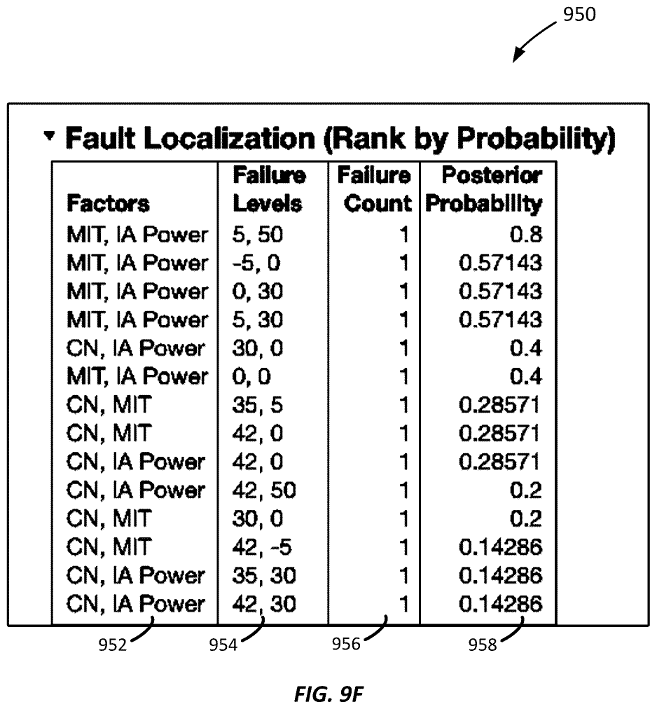

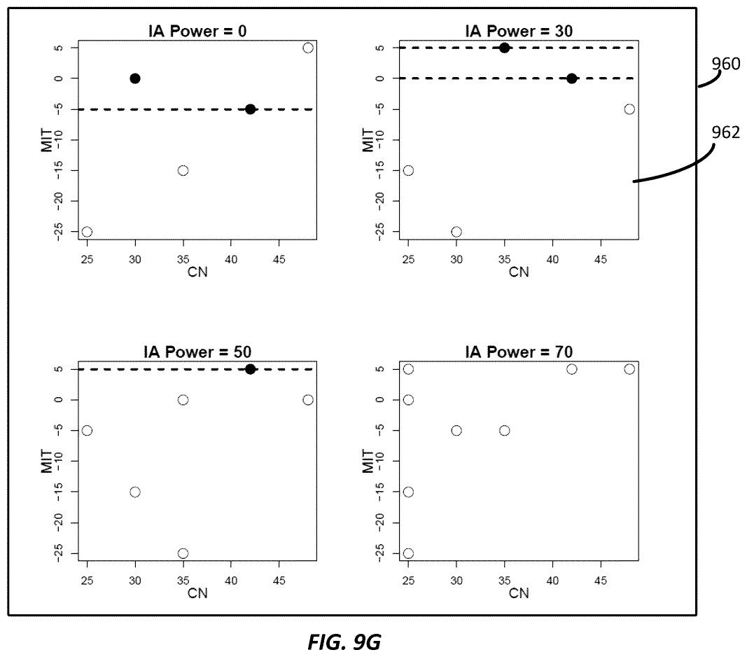

FIGS. 9A-9G illustrate graphical user interface(s) for indicating a ranking of combinations of factors with custom input to weighted priors (e.g., according to the method 800 in FIG. 8). Weighted prior in this sense are quantified assumptions about a parameter prior to new data observation. In this case, prior to further testing to determine the causes of an outcome, weights can be assigned to factors or combinations of factors. Embodiments provide improved graphical user interfaces that can receive quantified domain knowledge or structural knowledge that can be used by improved computing systems for determining an informed ranking and for limiting computations by the computing system for determining that informed ranking.

FIG. 9A illustrates a table 900 of a graphical user interface indicating factors in column 902 for an experiment. In this example, the experiment was for developing an engine control system for operating an energy-assisted compression ignition (EACI) engine. The factors affecting engine combustion include cetane number (CN), main injection timing (MIT), and IA Power. The outcomes include success and failure with a misfire indicating a failure. The experiment was to determine what operating conditions would lead to a misfire. Column 904 shows candidate levels for each of those factors for the experiment. For example, the cetane number could be “25” in some experiments or “30”. Embodiments are applicable to other factors and levels than the specific ones in this example.

In one or more embodiments, a computing system generates a test suite that provides test cases for the experiment. FIG. 9B illustrates a table 910 of a graphical user interface. Example test cases are shown in column 912 based on a strength 2 covering array.

Outcome data from testing the test cases can indicate a respective outcome from a set of outcomes for each test case of the test suite. For example, the set of outcome could include a failure indication indicating a test conducted according to the test case failed and/or a success indication indicating a test case succeeded. Column 914 shows responses from testing the test case with a “FAIL” indicating a misfire and a “PASS” indicating no misfire.

In this example, there can be several competing input combinations (e.g., specific candidate levels for one or more factors) that could be the cause of a failure. These competing causes are referred to as potential causes. Test engineers typically have prior knowledge of the system under test (SUT), including particular inputs and interactions that have been problematic in the past or changes that have not been rigorously tested. Additionally, they are more aware of failure inducing principles or assumptions and how they may apply to an experiment. For instance, with combination hierarchy principles, combinations involving fewer inputs are more likely to be failure-inducing than those involving more inputs, and combinations of the same order are equally likely to be important. With combination scarcity assumptions, the number of failure-inducing combinations will likely be small. With combination heredity principles, a combination is more likely failure-inducing if at least one of the parent factors involving the interaction is known to be more likely involved in inducing failures. Embodiments provide graphical user interface(s) allowing a test engineer to specify weights for levels of inputs, thereby providing a way to determine the ranking of potential causes.

Testing complex systems is a challenging task. Test engineers must create a set of test cases that can efficiently identify faults within the system, often while working under tight budgetary constraints. Covering arrays ensure that all possible combinations among t inputs appear in a test suite, where t is known as the strength of the covering array. When a test suite derived from a covering array is used, and all tests pass (i.e., produce the expected results), the test engineer can be confident that there are no faults due to combinations of inputs involving t or fewer inputs. Ideally, all tests would pass, but in cases where there are failures, the test engineer must identify the specific inputs and their levels that caused the failures.

Follow-up testing to pinpoint the cause of these issues can be costly, due to the oracle problem (i.e., determining the expected result). Therefore, engineers use care in designing and conducting follow-up test cases to manage costs effectively. Embodiments provide tools and methodologies in determining likely causes for conducting follow-up testing.

FIG. 9C illustrates a portion 920 of a graphical user interface for assigning an estimation as to a contribution of a recipient of the assignment to an estimated outcome for the experiment (e.g., based on prior beliefs). In this example, the outcome is a failure indication, and the graphical user interface allows users to specify relative weights (default is 1) for both individual factors and factor combinations as a measure of the user's prior belief in the suspiciousness or importance of these factors and combinations. These relative weights are then converted into prior root cause probabilities by a computing system, which are then combined with data evidence to provide a more informative ranking of all suspicious combinations. In this example, the user had prior beliefs for EACI engine combustion: misfire is more likely to happen with lower CN fuels or lower IA Powers; and larger MIT corresponds to shorter combustion duration and is more likely to cause misfire. In different experiments, the test case could involve multiple outcomes such as a misfire in a first period of time, a misfire in a second longer period of time, and a failure, or the experiment could be unrelated to failures.

FIG. 9D illustrates a portion 930 of a graphical user interface that allows a user to limit the maximum combination strength considered. FIG. 9E illustrates a portion 940 of a graphical user interface for selecting the extent of computation processing. In this case “medium” is selected. This can control the computational scale (e.g., a quantity of covers considered) and/or speed of the computing system at producing output (e.g., output shown in FIGS. 9F and 9G).

In this example, in order to provide a more informative ranking of the suspicious combinations that lead to the responses in column 914 of FIG. 9B, a Bayesian fault localization approach was used. The Bayesian approach is an improvement on deterministic analysis because it uses prior domain knowledge and data to rank suspicious combinations. A computing system determines probabilities for candidate causes. For example, a computer-generated probability could involve a ratio of prior root cause probability of potential root causes for a given outcome (e.g., “fail”) relative to an enumeration probability of an enumeration of a set of scenarios for that outcome involving the potential root causes.

FIG. 9C shows a means of specifying priors so that a test engineer can effectively and easily specify what they might know about the SUT. A computing system performs the analysis and provides an interactive set of results to make things digestible to a test engineer. For instance, FIG. 9F illustrates a table 950 of a graphical user interface. A column 952 shows the rankings of factors from a set of localization factors. In this case the computing displays a ranking pertaining to most likely potential causes for the failure outcome. Additionally, the causes here were a combination of factors, but individual factor(s) could have also been a potential cause. Column 954 includes levels for those factors that contributed to an outcome. In this example, the outcome is a failure outcome with column 956 showing the quantity of failures associated with factor combinations.

As shown here, if ranking was done only by the number of failures that are associated with the potential root cause, when many potential root causes share the same failure count, as in FIG. 9F column 956, it is hard to disentangle these potential root causes and find the most important ones among them. However, embodiments herein use more informative ranking of these potential root causes. In some embodiments, a computing system also displays computed metrics for determining the more informative ranking. For instance, column 958 shows a computer-generated probability for each combination of factors contributed to an outcome. The computer-generated probability in this example is based on an authorized extent of computational processing for generating the ranking (e.g., shown in FIG. 9E), and the assignment (e.g., shown in FIG. 9C). As shown in FIG. 9F, a graphical user interface can display the probabilities in proximity to the ranking (e.g., in table 950). The probabilities can better inform how much follow-up testing to conduct. Here, the combination of MIT (5) and IA Power (50) showed a much higher probability than any of the other combinations. The computing system could display different rankings such as most likely causes for success.

Based on the ranking, as IA Power increases, engines with larger MIT are more likely to misfire. This finding aligns with prior knowledge, where larger MIT, lower IA Powers or lower CN are associated with misfire. Incorporating prior knowledge into Bayesian fault localization could help to disentangle tied combinations shown in table 950 (all having a failure count of 1 in column 956) and provide a more informative ranking of suspicious combinations.

FIG. 9G illustrates a portion 960 of a graphical user interface displaying a graphical representation of outcome data. Design points are depicted with design cases receiving a pass indicated with a hollow dot and design cases receiving a failure a solid dot in a case study with twenty-four design cases. The top five ranked combinations are shown with dashed lines to identify a region based on the ranking. Regions can be useful for determining additional design cases (e.g., selecting MITs between 0 and 5 may be more likely to generate a failure according to graph 962).

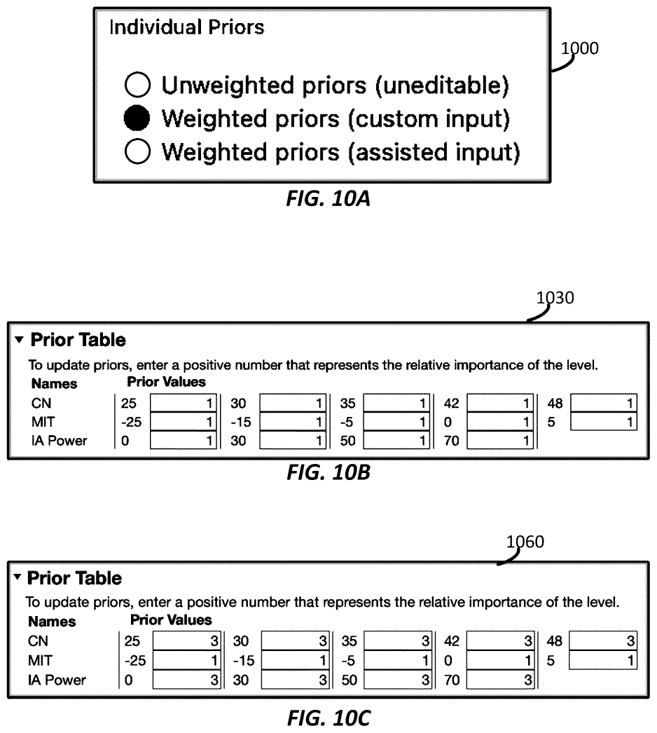

In one or more embodiments, a user can select a type of assignment for assignments to factors or combinations of factors. For instance, FIGS. 10A-10C illustrate graphical user interface(s) for receiving custom input to a weighted prior for an individual factor. FIG. 10A illustrates a portion 1000 of a graphical user interface allowing a user to change options for inserting a weighted prior. In this case the user has selected “weighted priors” allowing for “custom input”. In other embodiments, a selection can be predefined or the system may only utilize one or two of the options in portion 1000. FIG. 10B illustrates a portion 1030 of a graphical user interface responsive to the selection in portion 1000. The portion 1030 can be generated dynamically responsive to the selection in FIG. 10A or could be the default display. In this case all the assigned values are set to a default value of “1”. In some examples, a computing system receives the assignment by receiving a change, via a graphical user interface (e.g., changing in portion 1030), to a computer-generated assignment. For instance, FIG. 10C shows an updated portion 1060 where some of the values are changed from the default value of “1” to “3”. By specifying an exact value, a user can flexibly weight inputs.

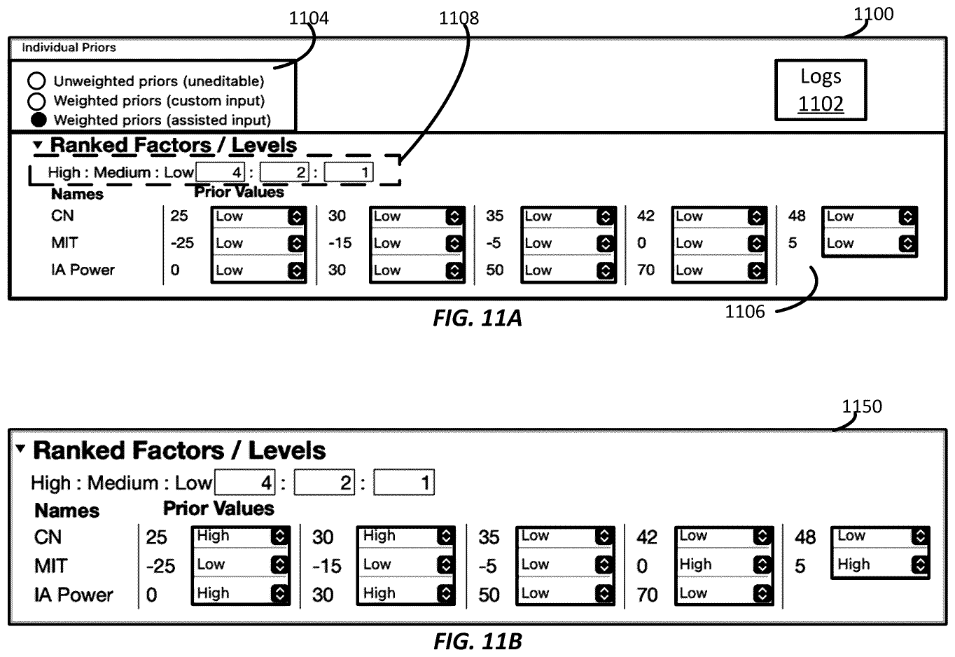

The portions 1030 or 1060 can be in a same window as portion 1000 or in a separate window. For instance, FIG. 11A shows a portion 1100 with a selection area 1104 for selecting the assignment type and an assignment area 1106 for inputting the assignment according to the assignment type.

In embodiments, a user can use a graphical user interface to change the type of assignment to factors or combinations of factors. The assignment area 1106 can update dynamically responsively to the selection in selection area 1104. For instance, FIGS. 11A-11B illustrate graphical user interfaces for receiving assisted input to a weighted prior for an individual factor. Assisted input can be useful for providing guided inputs such as “high, medium, low”, where a user does not wish to specify an exact value assignment in individual assignments. However, in embodiments, a graphical user interface can allow a user to configure interpretability of those inputs received by the computing system. For instance, input fields 1108 can receive input assigning a value to a particular, high, medium, or low assignment for operations by a computing system. In this case, the assigned values are uniformly spaced, but they need not be (e.g., “high” could be assigned a value of “8” to increase the relative weight of a “high” assignment). The assignments are showing as “low” in FIG. 11A rather than numerical assignments seen in FIGS. 10B-10C because the selection area 1104 shows a selection of “weighted priors (assisted input)”.

In any of the weighted prior options, there could be no initial displayed values responsive to a selection or the initial displayed values could be a default value (e.g., setting all values to the lowest indicator). Alternatively, or additionally, it could be informed by log data of previous experiment(s) involving one or more similar factors or combination of factors. For example, if the log data indicates an MIT of −25 is often involved in failures in other experiments, the default value for this could be “High”. Alternatively, or additionally, a control 1102, can be used to display log data in the graphical user interface for user consideration of changing the assigned values or to automatically adjust the default values based on the log data.

FIG. 11B illustrates a portion 1150 of the graphical user interface after the assigned values are changed. In this example, a computing system receives assignment of contribution of a recipient to an estimated outcome by receiving, via the graphical user interface, a selection of a relativity indication (e.g., selecting high instead of low). The relativity indication indicates a contribution of the recipient of the assignment relative to the contribution of a different factor or combination of factors for the set of multiple factors. For example, IA Power of “0” is assigned “High” indicating it provides a greater relative contribution than MIT of “−25” assigned “Low”. Alternatively, or additionally, the assignments could be based on log data.

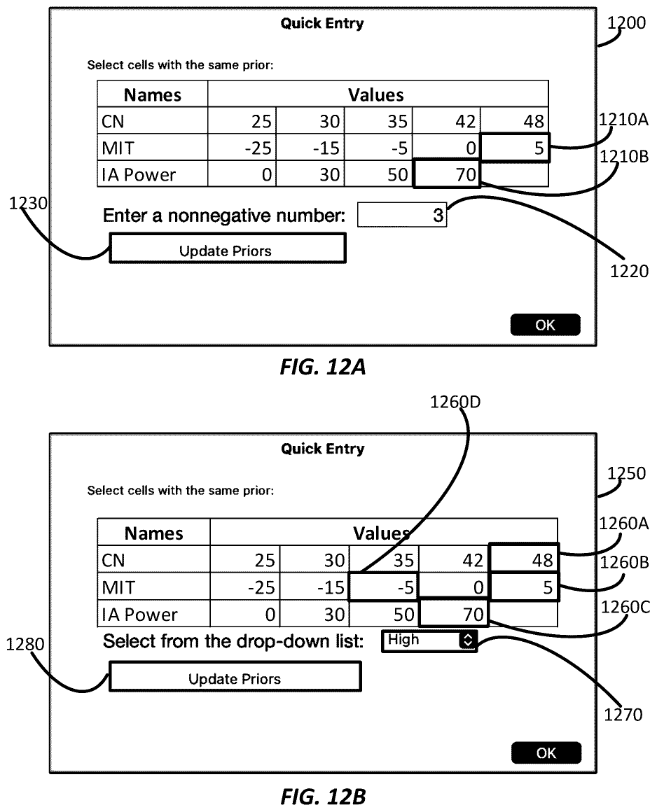

In some embodiments, a computing system receives an assignment by receiving, via the graphical user interface, a selection of selected factors or combination of factors, and receiving a single indication to assign to all in the selection. For example, FIGS. 12A-12B illustrates graphical user interfaces for receiving batch weighted priors to individual factors. FIG. 12A shows a graphical user interface 1200 with selection of cells 1210 representing individual factors, and shows a text box 1220 for entering a value for the selected cells. Selecting control 1230 updates the priors associated with the cells. FIG. 12B shows a graphical user interface 1250, where the selected value for multiple selected cells 1260 is a relativity indication. The priors for all the selected cells are updated by using selection control 1270 to select the relativity indication of “High.” Control 1280 is used to update the assigned priors for the selected cells 1260 to “High”.

Embodiments also provide graphical user interface for assigning estimation of contributions to an outcome to combinations of factors rather than or in addition to individual factors.

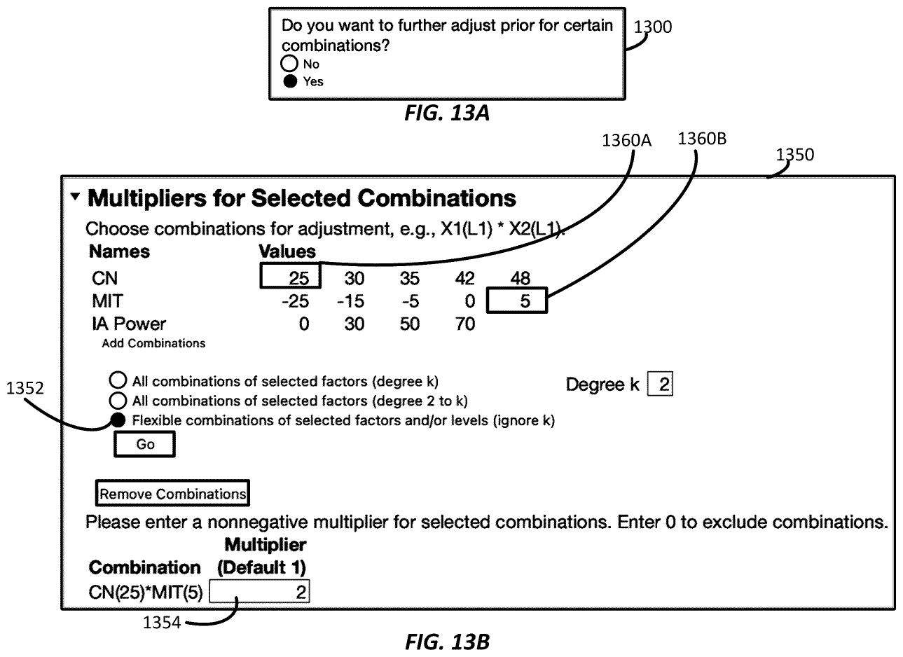

FIGS. 13A-13B illustrate graphical user interface(s) for receiving weighted priors for a combinations of factors. FIG. 13A shows a portion 1300 of a graphical user interface for selecting whether to provide assignments for additional priors for combinations of factors. FIG. 13B shows a portion 1350 of a graphical user interface for generating combinations. In this example, the computing system receives, via the graphical user interface, an indication to generate a computer-generated combination of factors from the set of multiple factors. For instance, the user uses options 1352 to set settings for generating combinations. The computing system can then receive, via the graphical user interface, an assignment for one or more generated combinations of the computer-generated combination of factors. For example, textbox 1354 can be used to provide input as to an assignment for a combination of factors. Embodiments are also useful for when the is no domain knowledge or structural knowledge the user has.

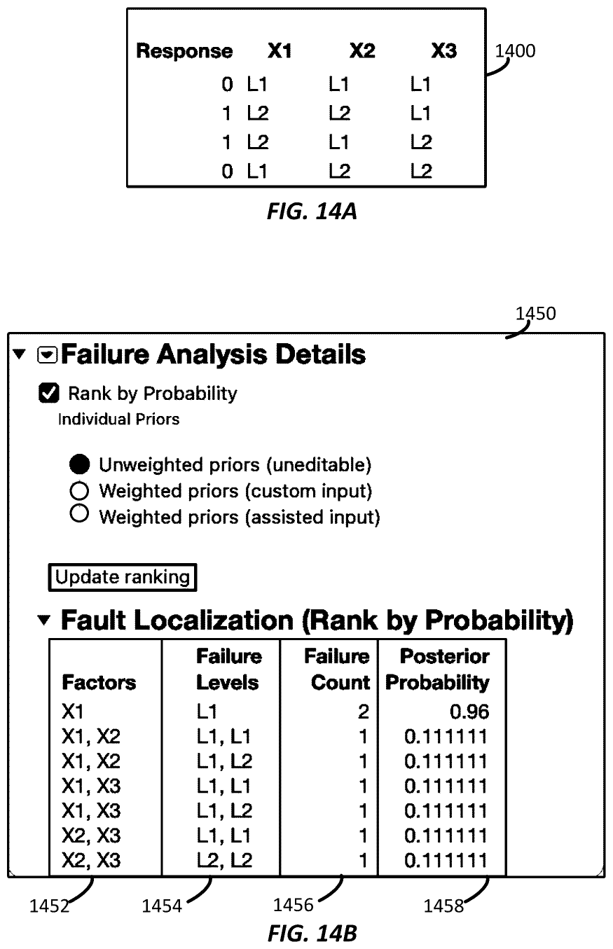

FIGS. 14A-14B illustrate graphical user interfaces for unweighted priors. FIG. 14A shows a portion 1400 of a graphical user interface with example test cases. FIG. 14B shows a portion 1450 of a graphical user interface with a selection of unweighted priors for the test cases in FIG. 14A. FIG. 14B shows a selection of “Unweighted priors”, which can be useful when there is no domain knowledge or structural knowledge available. In this example, fault localization techniques can still provide probabilities for factors or combinations of factors involved in the test cases. For instance, column 1452 shows a ranking of factors. Column 1454 shows the levels for those ranked factors involved in the failure. Column 1456 shows a failure count. Column 1458 shows the probability. As one would expect with a factor involved in two test cases, the probability is highest that that would be the failure inducing culprit, which is supported by the probabilities.

Embodiments are applicable to other industries than those specifically addressed here such as other incidences where there is an outcome (e.g., a binary response or multi-response) and the goal is to identify input (e.g., factors and levels) that explain that outcome. For instance, embodiments are useful for software testing and validation, as well as fault diagnosis of complex engineered systems, especially safety critical systems. Such systems include embedded digital devices in nuclear power plants, electronic control units in automobiles, medical devices, such as point of care diagnostic devices, etc. These embedded devices may be implemented in hardware or software, and they may be, or connected to, sensors and/or Internet of Things (IoT) devices. Fault diagnosis of point-of-care diagnostic devices is particularly important as these devices are becoming an increasingly popular method for diagnosis of infectious and genetic diseases. Diagnostic errors result in poor patient outcomes and, as a result, it is important that the root causes of failures in such devices can be quickly and accurately identified. Other complex engineered systems may unite advanced multi-disciplinary approaches involving various technical fields to formulate a suitable model (e.g., the power grid, clean water solutions, carbon sequestration methods, or securing cyberspace.)

Software testing is essential for the reliable development of complex software systems. Software testing—the process of executing a program with the intent of finding errors—is an essential step in the development of robust software applications. Such testing aims to reveal and subsequently fix as many bugs (i.e., faults) as possible prior to the deployment of a software application, thus greatly reducing the likelihood of encountering failures for the end-user. There are, however, two fundamental challenges in software testing. First, each software test can be time-consuming to perform. This involves not only running the software system itself, which can be intensive for modern scientific applications, but also determining whether the software deviates from its expected behavior. The latter, known as the “oracle problem”, typically requires an independent assessment of numerical accuracy of software outputs, which can be very costly. Second, the number of test cases required for thorough software examination can easily be overwhelming. For practical applications, it is infeasible to exhaustively test all input combinations, which can easily require billions of test cases.

Addressing these challenges can go in a number of different directions or techniques. For instance, different techniques could involve carefully designing test cases to perform with the joint goals of identifying failure settings and diagnosing its underlying root causes. Statistically, this can be viewed as an experimental design problem for software fault diagnosis. With the initial test cases conducted and failures detected, a second direction is fault localization: the use of this test data to pinpoint root causes (e.g., pinpoint failure-inducing combinations for further diagnosis). This is a highly challenging problem due to the overwhelming number of scenarios to consider for potential root causes. To see why, consider a software application with ten input factors each with two levels. For this system, there are a total of

$${\sum }_{i = 1}^{10} ( \begin{matrix}10 \\ i\end{matrix} ) {2}^{i} = 59 , 048$$

input combinations that might be potential root causes; these consist of all single factors, two-factor combinations, and so on. Since each combination is either a root cause or not, this results in a whopping 2⁵⁹⁰⁴⁸ different scenarios to consider for potential root causes. Fault localization requires gauging which of these many scenarios is likely given test set outcomes, which is clearly a computationally intensive task, even for systems with a moderate number of inputs and few failed test cases. Furthermore, the debugging cost for investigating each such scenario can be considerably high.

Embodiments improve upon traditional fault localization methods by incorporating domain and/or structural knowledge from test engineers, and/or providing a probabilistic assessment of risk for potential root causes. Domain knowledge can refer to prior information that may raise or reduce the suspiciousness of certain input factors; this may come, e.g., from historical data, expert judgment or specific characteristics of the system. Structural knowledge captures expected fault behavior from an understanding of the software's architecture and how components interact. Embodiments also utilize improved Bayesian fault localization framework, which leverages a flexible Bayesian model for identifying potential root causes with probabilistic uncertainty. Using a carefully specified prior on root cause probabilities, embodiments permit the integration of domain and structural knowledge via the principles of combination hierarchy and heredity, which capture the expected structure of failure-inducing combinations. A probabilistic approach can further accelerate fault localization by disentangling the many tied combinations given limited test runs.

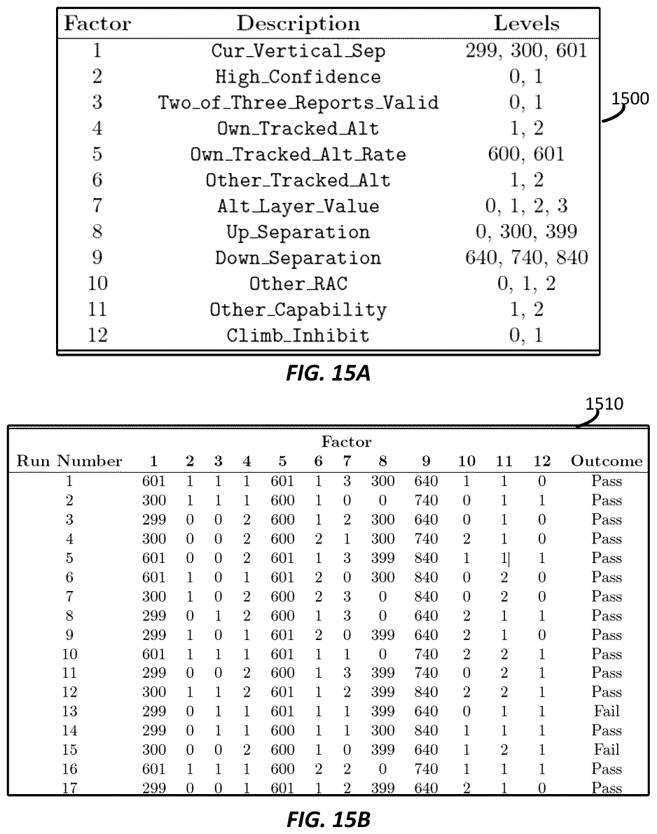

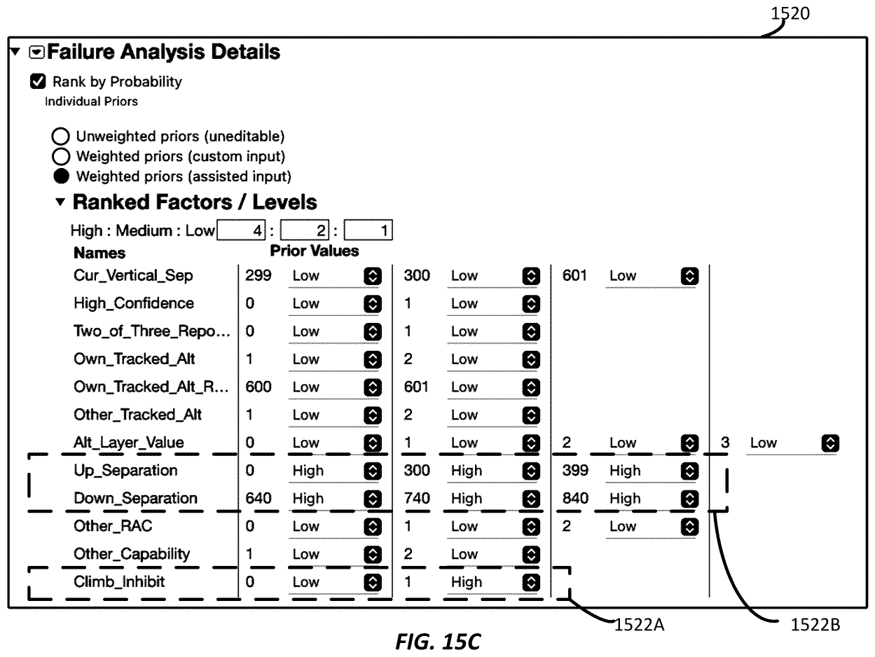

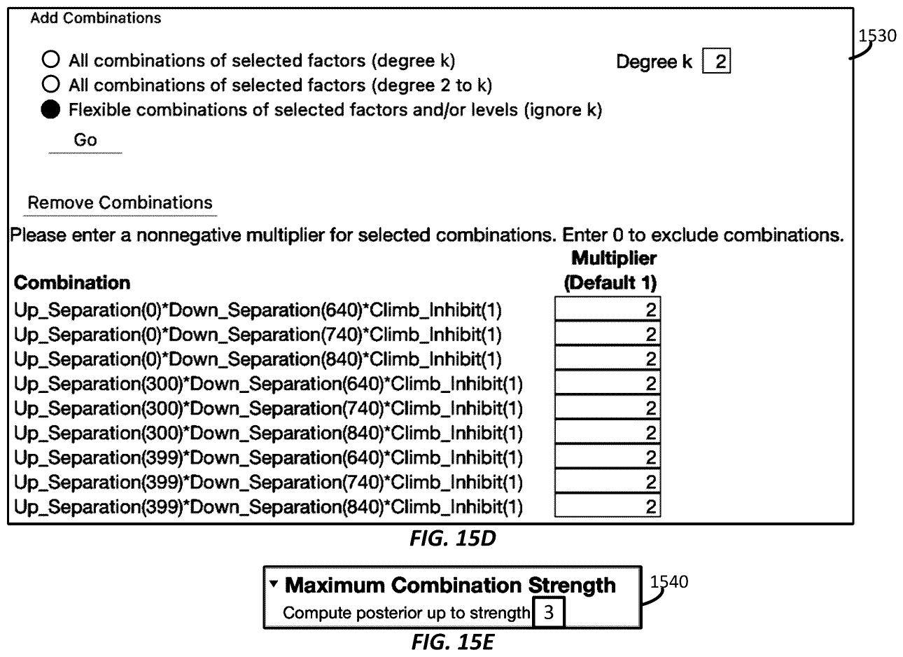

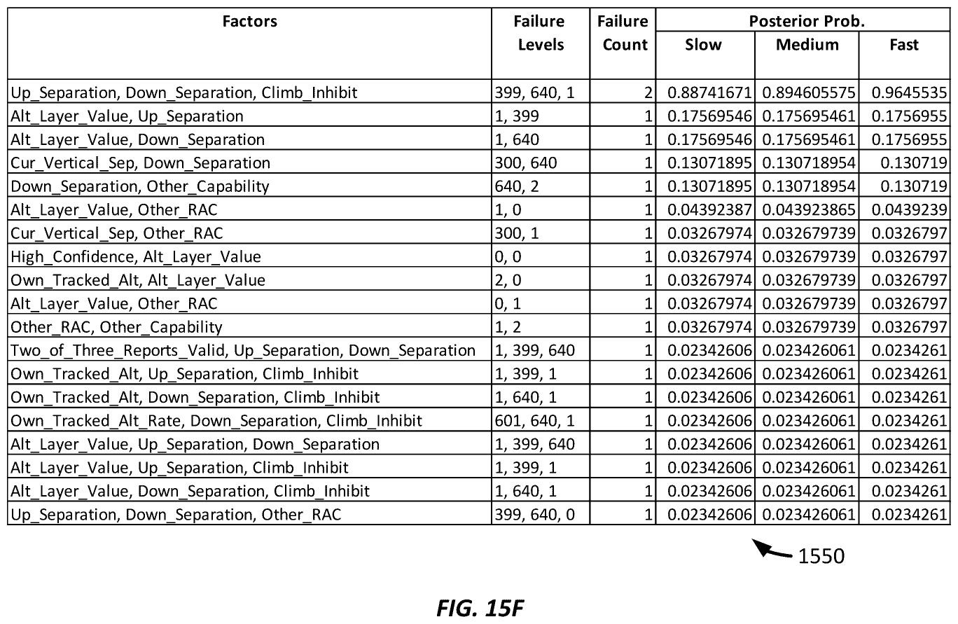

FIGS. 15A-15F illustrate graphical user interfaces for indicating a ranking of combinations of factors with assisted input to weighted priors for an example involving a complex system involving software, mechanical and electrical systems.

FIG. 15A shows a portion 1500 of a graphical user interface displaying factors for a Traffic Alert and Collision Avoidance System (TCAS). TCAS is an aircraft collision avoidance system designed to prevent potential mid-air collisions between aircraft. TCAS monitors the airspace around an aircraft and determines a protection volume around the aircraft based on the aircraft's speed and trajectory. When two aircraft come too close either horizontally or vertically, TCAS alerts the pilots by issuing a resolution advisory. TCAS is currently mandated for U.S. commercial aircraft and is also installed on many helicopters and turbine-powered general aviation aircraft. Given the catastrophic implications of aircraft collisions, it is paramount to mitigate such risks by ensuring the reliability of TCAS systems via comprehensive testing under different scenarios. Portion 1500 shows a table with 12 factors where each factor parameterizes certain characteristics of the aircraft system and corresponding levels for the factors. Nine of the factors pertain to the primary aircraft and reflect operating conductions such as current altitude, altitude rate-of-change, and separation altitudes with the incoming aircraft. The other three factors are for the incoming aircraft that has entered a protection volume of the primary aircraft which reflect the altitude (“Other_Track_Alt”), resolution advisory (“Other_RAC”), and TCAS capability of the incoming aircraft (“Other Capability”).

FIG. 15B shows a portion 1510 of a graphical user interface for test case of a study to find the root causes (e.g., certain combinations of one or more factors) that could lead to some known failure in the system. The portion 1510 shows a table of test cases based on a 17-run strength-2 covering array. To show the usefulness of embodiments, it was known in this study that the true root cause of the failures is a three-factor combination (Climb_Inhibit=1), (Up_Separation=399), (Down_Separation=640). The data shows two failures as a result of that combination. Ordinary suspicious combinations of lowest order are ranked based on failure counts. Given the quantity of factors than there could be at least ten suspicious two-factor combinations as shown in Table 1, and none of those combinations is the true root cause. Because they are all involved in only one failure, there is not enough evidence to rank their suspiciousness, so all ten combinations would need to be eliminated.

TABLE 1

| Factor 1 (Level) | Factor 2 (Level) |
|---|---|
| Cur_Vertical_Sep (300) | Down_Separation (640) |
| Cur_Vertical_Sep (300) | Other_RAC (1) |
| High_Confidence (0) | Alt_Layer_Value (0) |
| Own_Tracked_Alt (2) | Alt_Layer_Value (0) |
| Alt_Layer_Value (1) | Up_Separation (399) |
| Alt_Layer_Value (1) | Down_Separation (640) |
| Alt_Layer_Value (0) | Other_RAC (1) |
| Alt_Layer_Value (1) | Other_RAC (0) |
| Alt_Layer_Value (640) | Down_Separation (2) |
| Other_RAC (1) | Other_Capability (2) |

A key challenge here is the expensive testing cost for each run of TCAS. A “failure” in a software program is when its actual behavior deviates from its expected behavior. Here, the assessment of the latter requires the construction of eleven data collection sites over the U.S., and requires the collection of ground radar data (spanning hundreds of hours) for generating encounter databases. Logic test simulations are performed on thousands of such encounters, and physical experiments are then conducted to validate its real-world performance. Coupled with the many potential root cause combinations from the 12 input factors, such testing costs make the exhaustive testing of TCAS over all combinations wholly impractical.

An effective solution is to first construct a small, designed test set of input settings (e.g., a covering array which covers each input combination (up to a certain order). FIG. 15B shows a portion 1510 of a graphical user interface displaying a strength-2 covering array for the TCAS case study with 17 runs, which greatly reduces the number of validation runs on the expensive software system. With this covering array, all single inputs and two-factor input combinations are investigated in at least one test run. If there is a bug within such combinations, the outcome data would show a corresponding failure in a test run.

The next step is to use this test run data to identify potential root causes, i.e., the problem of fault localization. A key challenge here is that there are more than

$${\sum }_{i = 1}^{12} ( \begin{matrix}12 \\ i\end{matrix} ) {2}^{i} > 500 , 000$$

input combinations (e.g., the two-factor combination Cur_Vertical_Sep=299 and High_Confidence=0) that may be failure-inducing root causes. Since each combination is either a root cause or not, there are thus 2^{500,000} different root cause scenarios to consider for fault localization. The goal is to parse through these many scenarios to find which are likely given the observed test results. With the costly nature of debugging, this set of likely scenarios should further consist of only a few combinations, to facilitate cost-efficient downstream diagnosis. Another challenge is the need for assessing confidence that an identified suspicious combination is indeed a root cause. Embodiments provide test engineers a principled way to decide which combinations are likely root causes that need to be further investigated, and which are likely not root causes and can be safely ignored. Such uncertainty quantification is helpful for trustworthy fault diagnosis.

FIG. 15C shows a portion 1520 of a graphical user interface. In this example the failures were investigated, and a test engineer determined that the failures were both caused by an “unresolved” resolution advisory of the TCAS computer program. That type of failure is likely to be associated with certain levels of Up-Separation, Down_Separation, and Climb_Inhibit. The portion 1520 can be used to assign “high” prior weight to them and keep others at “low” suspicion level in the user interface in the assignment areas 1522.

FIG. 15D shows a portion 1530 of a graphical user interface in which assignments are assigned to failure combinations. In this case, as the failure may be associated with all three different factors (e.g., Climb_Inhibit, Up_Separation, and Down_Separation), the graphical user interface is used to generate 3-factor combinations involving Up Separation, Down Separation and Climb Inhibit and assign multiplier 2 to each of them.

FIG. 15E shows a portion 1540 of a graphical user interface in which the maximum combination strength is set to 3 so that 3-factor combinations are also considered in the search of potential root causes.

FIG. 15F shows a portion 1550 of a graphical user interface showing output from running fault localization with three different speeds—fast but least accurate, medium (recommended), and slow but most accurate. This setting controls the maximum number of set covers (i.e., maximum number of possible explanations of failures) found in the fault localization procedure, and thus affecting the accuracy of final calculation. The top-ranked failure was found using all three computational processing speeds and is the true root cause. The posterior probabilities were also notably similar. Therefore, incorporating prior knowledge into Bayesian fault localization could provide a more informative ranking of suspicious combinations. Even in a short amount of processing time can reveal important factors to consider.

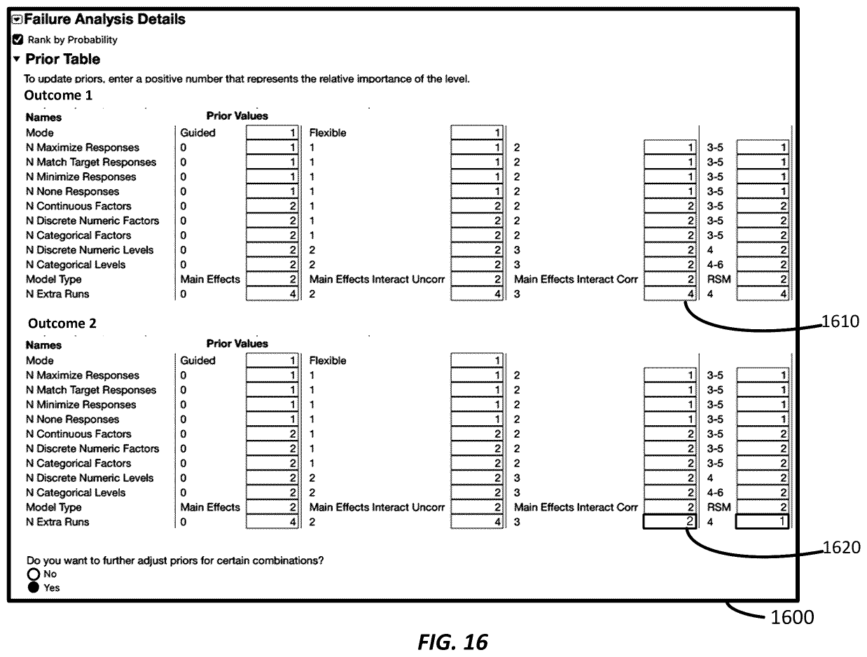

Embodiments are not limited to only exploring singular output types. For instance, FIG. 16 illustrates a graphical user interface 1600 for different weighted priors for different outcomes (outcome 1, outcome 2). The outcomes in this case came from testing JMP's Easy DOE Platform, which offers an end-to-end guided solution for design of experiments. The graphical user interface FIG. 16 lists the input factors and their corresponding levels used in Easy DOE. For instance, the “N Extra Runs” factor indicates the number of additional runs beyond the default sample size.

In some embodiments, a computing system receives multiple assignments for a given factor, or combination of factors, where the assignments are for contributions to different outcomes. For instance, the computing system receives via the graphical user interface 1600, the assignment by receiving for a factor pertaining to “N Extra Runs” of the set of multiple factors a first assignment specific to a first outcome of the at least two outcomes (e.g., an assigned “4” for contribution to outcome 1 in field 1610 for option of 3 runs), and a second assignment specific to a second outcome (e.g., an assigned “2” contribution to outcome 2 in field 1620 for option of 3 runs). For instance, if option 1 pertained to failure with a short time window, the importance of having extra runs may be greater for detecting a failure (because it may fail, but in some runs may take longer to fail, which may get missed). If option 2 pertained to failure in a long period of time, the importance of having extra runs may be less important for detecting that failure type.

In other embodiments, a graphical user interface could also have different assignment areas of a graphical user interface for the same outcome but different models or experiments to explore. Embodiments advantageously enable outcome-specific, model-specific, and/or experiment-specific assignments.

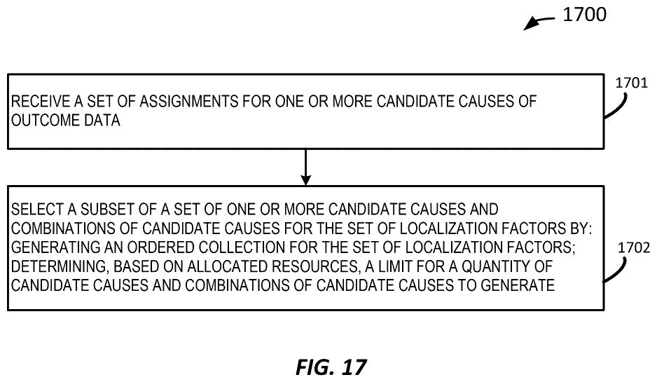

One or more embodiments use input of assignments or processing constraints to provide an approved method for selecting candidate causes. FIG. 17 illustrates a flow diagram for a method 1700 for selecting candidate causes for a test suite. For example, the method 1700 can be implemented by a computing system (e.g., system 700 and/or computing device 760).

The method 1700 includes an operation 1701 that includes receiving the assignment (e.g., an assignment received through a graphical user interface) by receiving a set of assignments for one or more candidate causes of the outcome data. The method includes an operation 1702 of selecting a subset of a set of one or more candidate causes and combinations of candidate causes for the set of localization factors. For instance, the set of localization factors could be individual factors like those shown in FIG. 15A such as Climb_Inhibit. However, candidate causes can refer to a single factor or multiple factors that could have caused an outcome (e.g., 2-factor combinations such as Climb_Inhibit and Other Capability). Operation 1702 can include generating an ordered collection for the set of localization factors, and determining, based on the resources, a limit for a quantity of candidate causes and combinations of candidate causes to generate. Operation 1702 could include additional operations described in embodiments herein such as a methodology for processing the localization factors (e.g., according to the limit).

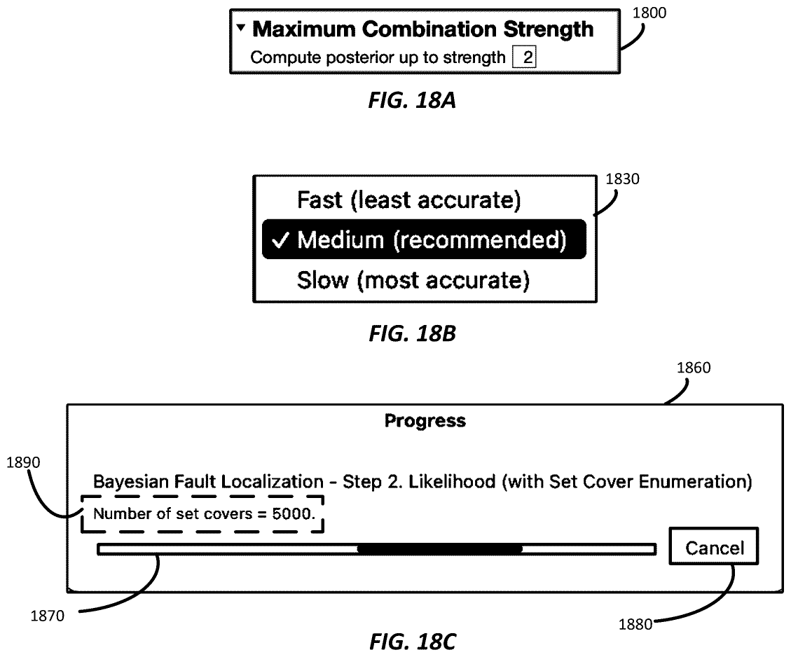

FIGS. 18A-18C illustrates graphical user interfaces for receiving a limit for a quantity of candidate causes. FIG. 18A illustrates a graphical user interface 1800 for inputting a strength. This graphical user interface allows maximum combination order for computations to be user-defined in embodiments.

FIG. 18B shows an example graphical user interface 1830 with different processing constraints. For instance, selecting “fast” could mean the computing system is limited to exploring at most 200 covers (factors or combinations of factors to explore). Since this is a limited number of covers, it is deemed the “least accurate” in this example. Selecting “medium” could mean the computing system is limited to exploring at most 5000 covers so it is deemed the “recommended” as presenting a balance in the trade-offs in accuracy and speed. Selecting “slow” could mean the computing system is unlimited in the number of covers or a very high amount such as 1 million, so it is deemed the “most accurate”. This graphical user interface can allow users to limit the scope or choose higher-speed settings for large or complex problems. Previous approaches to solving large problems could take hours or even days if all covers had to be identified under traditional Bayesian approaches. By using computation limits and reducing the number of set covers explored, the run time can be reduced to seconds.

FIG. 18C shows an example graphical user interface 1860 providing information to a user on the progress such as the number of sets explored in portion 1890 and a progress bar 1870. It is possible the progress could take longer than anticipated, so a control 1880 allows a user to terminate the process and redefine the processing limits. Information messages could also appear in the graphical user interface 1860 responsive to the control 1880 such as a “Bayesian fault localization has been cancelled. Please review the settings and try again.”

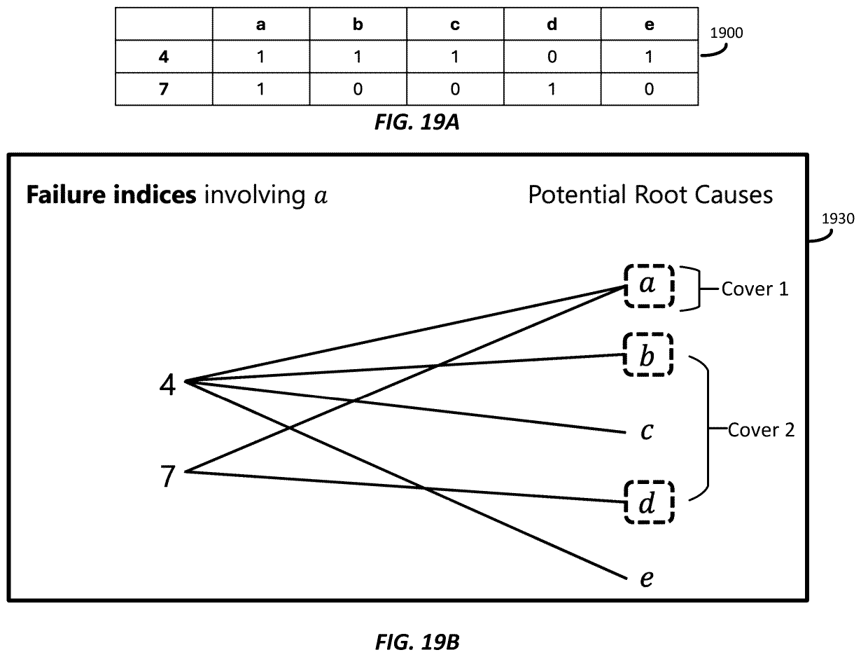

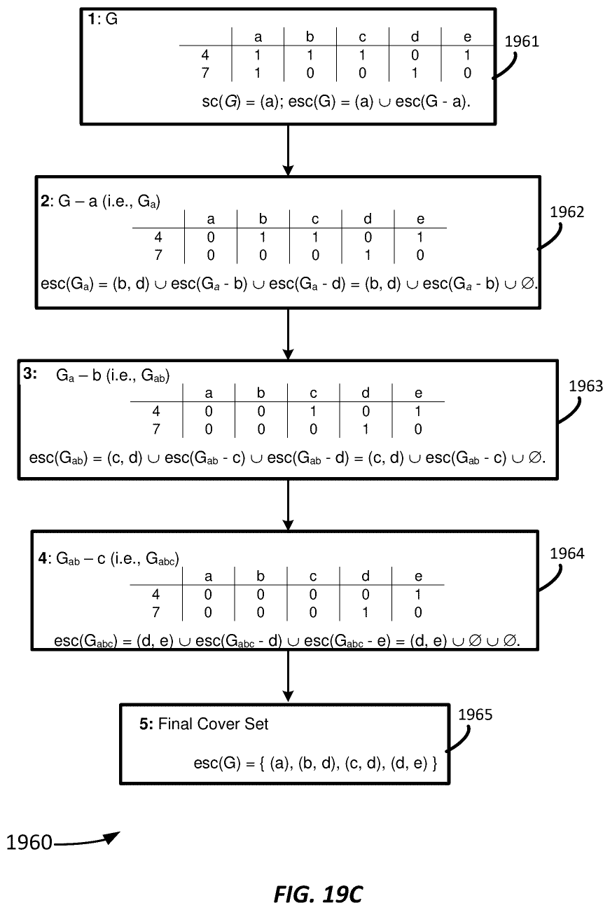

FIGS. 19A-19C illustrate a subset of candidate causes selected according to embodiments described herein (e.g., method 1700 in FIG. 17). FIG. 19A illustrates an initial set of factors with options between 0 and 1 for test cases. Here the outcome data had at least two test cases of a same outcome (test case 4 and 7). In this example, a computing system uses an alternative approach for Bayesian Fault Localization to determine a ranking of potential root causes. A root cause is the source of the outcome. This alternative approach can be described as:

$$P ( {Z}_{( i , j )} = 1 \vert D ) = P ( {Z}_{( i , j )} = 1 \vert {E}_{( i , j )} ) = \frac{{P}_{( i , j )}}{P ( {E}_{( i , j )} )}$$

where
Z_{(i,j)} where this is 1 if the potential root cause indexed by (i,j) is a root cause;
D represents observed data;
E_{(i,j)} represents all scenarios where all failures involving (i,j) can be explained; and
P_{(i,j)} represents a prior root cause probability of potential root cause (i,j).

In this example, i and j are sets such that depending on the combination i and j could have multiple different values. For instance, in a two-factor combination where there is factor 1 with level A input, factor 2 with level B input, then i=(1,2), and j=(A,B). If there was a three-factor combination where factor 1 has level A input, factor 2 has level B input, and factor 3 has level C input, then i=(1,2,3), and j=(A,B,C). The set elements could be organized differently.

Embodiments efficiently enumerate these scenarios in E_{(i,j)} by using a bipartite mapping and novel set cover enumeration algorithm to facilitate the Bayesian calculation.

FIG. 19B illustrates a bipartite graphical representation 1930 of a bipartite mapping with only 2 failures and only five potential root causes, where:
V₁={4,7}: is derived from the set of test cases (e.g., where failure indices)
V₂={a, b, c, d, e}: set of factor combinations.

Even in this simple case, there are multiple possible explanations of the failures, and the bipartite graph finds subsets C⊂V₂ that can cover V₁. Since each potential root cause (denoted by (i,j) above) is associated with one or more failures, then the relationship between potential root causes and failures is an incidence structure which can be represented by a bipartite graph. As shown in the bipartite graphical representation 1930, the two sets V₁ and V₂ are disjoint and independent. Based on the bipartite mapping, a computing system can determine a scenario of factors or combinations of factors that could account for the same outcome in the at least two test cases. For instance, Cover 1 explores factor “a” as a potential root cause, since it was involved in both failure cases, and Cover 2 explores a combination of factors “b” and “d” as a potential root cause, since at least one of them was involved in both failure cases. A computing system can then generate a set of localization factors for localizing the cause of the outcome (e.g., failure) and the ranking based on the bipartite mapping.

FIG. 19C shows an example flow diagram of a method 1960 for set cover enumeration. Let the set of failures be V₁={4, 7}(i.e., the row indices of a test set), the set of potential root causes be V₂={a, b, c, d, e}, and let E={{a,4}, {a,7}, {b,4}, {c,4}, {d,7}, {e,4}}. For the method 1960 the bipartite graph G=(V₁∪V₂, E) is shown in FIG. 19B, and its incidence matrix is shown in FIG. 19A. The method 1960 is applicable to other bipartite graphing and incidence matrixes.

The method 1960 is useful for identifying possible minimal subsets of the set of potential causes where each subset accounts for all failures. Each of these subsets is known as a minimal set cover and so the identification of all such subsets is set cover enumeration (or the enumerated set cover) problem. In an operation 1961, G=(V₁∪V₂, E) is bipartite graph representing the relationship between potential root causes and failures, with V₁ the set of failures and V₂ the set of potential root causes. C⊆V₂ is a minimal set cover of G, denoted sc(G), if the neighborhood of C (i.e., N(C)) is V₁ and, ∀cϵC, N(C†c)≠V₁. The enumerated set cover of G, denoted esc(G), is defined as follows:

$$esc ( G ) = sc ( G ) ⋃ ( {⋃}_{{w}_{i} ∈ sc ( G )} esc ( G - {w}_{i} ) )$$

This recurrence relation has been implemented as a recursive function. There can be thousands of minimal subsets for even modestly sized problems but, there is usually substantial overlap as the recursion unfolds. This overlap, sometimes referred to as common substructure, usually leads to substantial degradation of performance and so the implementation detects where there is common substructure to aid performance. This performance enhancement, along with several others, makes the implementation substantially faster than an integer programming approach. The following simple example illustrates the problem. For ease of understanding, this example does not exhibit common substructure.

Following this approach, operation 1961 shows computing a first set cover in G, in this case set {a}. In this example, the ordered collection is a sequence for factors arranged alphabetically “a” to “e”. Operation 1962 shows operations to compute a next subset after “a”, in this case {b, d}. Operation 1963 shows operations to compute a next subset after “b”, in this case {c, d}. Operation 1964 shows operations to compute a next subset after “c”, in this case {d, e}. Operation 1965 results in a final cover set.

In one or more embodiments, a computing system receives, via the graphical user interface, a strength for the bipartite mapping, and generates the ranking based on the strength for the bipartite mapping. For instance, FIG. 18A shows a graphical user interface 1800 for receiving a strength which can be used for the bipartite mapping. In this case, a strength of 2 was selected so only combinations of two candidate causes are explored.

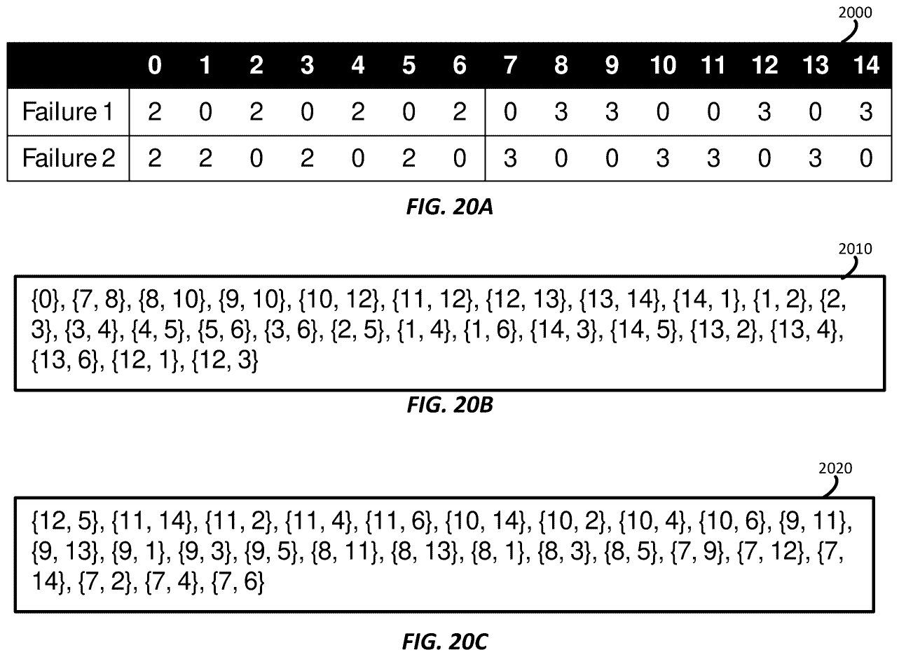

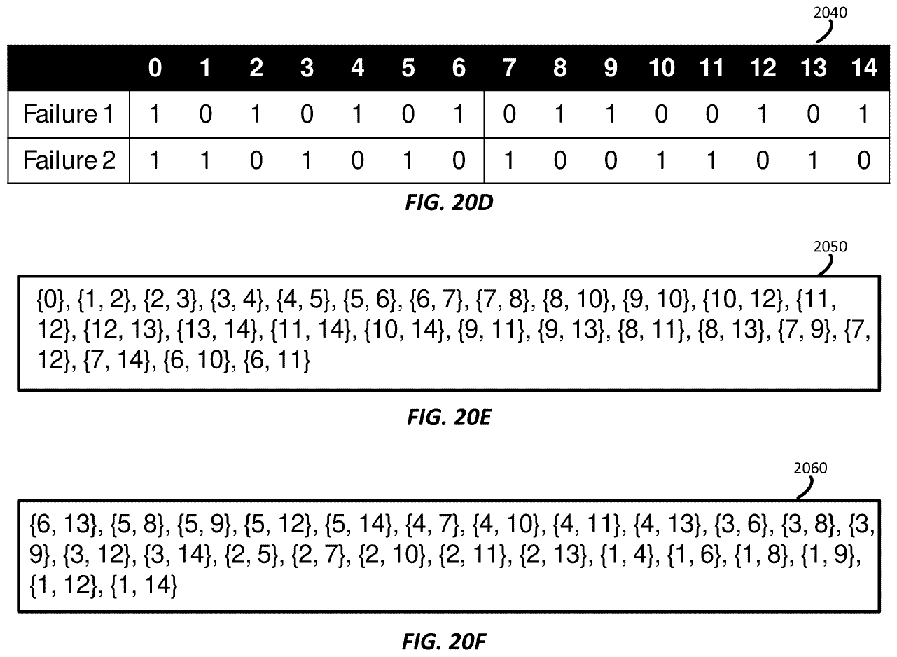

Embodiments also allow setting processing limits, which can be useful in more complex examples where there can be thousands of potential covers. For instance, FIG. 18B shows a graphical user interface 1830 for setting processing limits. FIGS. 20A-20F illustrates generating subsets of candidate causes based on different processing limits.

FIG. 20A shows a table 2000 of example ordered collection of candidate causes. Candidate causes involving two factors are indexed in an ordered collection by 0-6 and candidate causes involving three factors are indexed in the ordered collection by 0-14 in this example. The ordered collection is ordered and indexed based on a quantity of candidate causes in a given element of the ordered collection with two factor combinations indexed at the beginning of the ordered collection. Other schemes could be used such as a random indexing. Additionally, there could be more or less indexed combinations. For instance, the ordered collection could have more or less combinations of factors indexed that could contribute to an outcome (e.g., four factor combinations). Alternatively, or additionally, there could be more or less than six of combination types contributing to an outcome. In this example, the outcome is a failure, but the techniques described could be used for any outcome type. The ordered collection is processed numerically based on the index.

In embodiments, if there is a limited amount of set covers (e.g., due to processing constraints), it can be preferable to prioritize exploring two-factor combinations over three-factor combinations (e.g., including more combinations indexed 0-6). FIG. 20B shows a portion of a graphical user interface 2010 with set covers limited to twenty-five. It can also be useful to utilize weights. In FIG. 20B, the indexed combinations are weighted for their contribution to the failure indication (e.g., based on assignments received in a graphical user interface as described herein). In FIG. 20A, the table 2000 weights indexes for each of the failures from 0 to 3.

In FIG. 20B, the computing system selects, according to the ordered collection in FIG. 20A, the limit for the quantity of set covers, and the weights, any individual candidate causes that explain the outcome data. For instance, FIG. 20B shows selecting a candidate cause of {0} in FIG. 20B. Set {0} is the only combination found in both failures and is identified first according to the ordered collection.

Alternatively, or additionally, embodiments select, according to the ordered collection, the weights, and the limit, a first combination of two candidate causes from the ordered collection that has a highest combined value of any two-cause combinations from the ordered collection. For instance, by excluding {0} and searching for another cover, the next set selected is {7,8} because it has the largest sum of entries (3+3>3+2>2+2). The additional sets in FIG. 20B can be selected by starting in the ordered collection immediately after a first candidate cause of the first combination of two candidate causes (i.e., immediate after “7”), and selecting for the set of localization factors, according to the ordered collection and the limit, a second combination of candidate causes that has a highest combined value of any remaining combinations in the ordered collection (i.e., excluding 7 from the previous cover and search for another cover with sum of entities is set {8, 10} with weighted sum also of 6). Candidates are selected in accordance with the ordered collection (e.g., {9, 10}, {10, 12}). When the computing system reaches the end of the sequence, the computing system selects the next subset by determining that an end of the ordered collection is reached; and processing a beginning of the ordered collection again to determine a next combination of candidate causes for the set of localization factors (e.g., {14,1}). Other schemes could be used such as checking pairs at a random interval in the ordered sequence.

Due to a first processing limit, only the sets in FIG. 20B would be selected. However, FIG. 20C shows additional sets that would be selected when the processing limit is increased. In other words, the sets selected would include both the sets in FIGS. 20B and 20C. FIG. 20C shows a graphical user interface 2020 with the additional covering sets selected if the processing limit were instead set to fifty (i.e., the additional 25 covering sets).

In some embodiments, the processing limit and/or quantity of combinations of candidate causes can be greater than two pairs as shown here. In which case, a computing system could select the subset by determining that a quantity of two candidate causes for selection in the subset is less than the limit; and responsive to the determining the quantity is less than the limit, selecting, according to the ordered collection and the limit, a first combination of three candidate causes from the sequence that has a highest combined value of any three-cause combinations from the ordered collection. For instance, the set {7,8,9} would have a combined sum of 3+3+3 or 9.

Covering sets in FIG. 20B and FIG. 20C were determined using a weighted incidence matrix from the weights in table 2000. Using a weighted incidence matrix can increase the quantity of two-factor combinations. For instance, in FIG. 20B, eighteen out of the first twenty-five sets of covers contain two-factor combinations (indexed 0-6). FIGS. 20D-20F show that by using an unweighted incidence matrix, only nine out of the first twenty-five set covers contain two-factor combinations.

In FIG. 20D, the table 2040 uses a “1” instead of specific failures for when combinations appeared in a failure indication rather than weighting in with a “3” or a “2” as in FIG. 20A. FIG. 20E shows a graphical user interface 2050 with a first set of twenty-five covers, and FIG. 20F shows a graphical user interface 2060 with additional twenty-five covers if the processing limit is fifty. Embodiments provide an improved method of localizing inputs in a multi-response system by providing computing systems to account for processing constraints and assigned weights for factors or combinations of factors.

1. A computer-program product tangibly embodied in a non-transitory machine-readable storage medium, the computer-program product including instructions operable to cause a computing system to:
display a graphical user interface comprising:
a set of multiple factors for an experiment;
a control element for controlling an extent of computational processing for the set of multiple factors; and
an input element for receiving an assignment to at least one factor or at least one combination of factors from the set of multiple factors, wherein the assignment indicates an estimation as to a contribution of a recipient of the assignment to an estimated outcome for the experiment;
receive an indication of an authorized extent of computational processing via the control element;
based on the indication of the authorized extent of computational processing, dynamically allocate resources at the computing system for generating a set of localization factors, wherein the set of localization factors are for localizing one or more of the set of multiple factors influencing a given outcome for the experiment or an experiment model for the experiment;
receive the assignment via the input element of the graphical user interface;
select a subset of a set of one or more candidate causes and combinations of candidate causes for the set of localization factors;
obtain outcome data that is based on conducting the experiment or executing the experiment model, wherein the outcome data indicates at least two outcomes from conducting the experiment or executing the experiment model; and
control the graphical user interface to display a computer-generated prediction for the outcome data by generating, based on the outcome data, the indication of the authorized extent of computational processing, and the assignment, a ranking of a first combination of factors and a second combination of factors from the set of localization factors, wherein the first combination of factors and the second combination of factors are different; and
wherein the ranking is based on a computer-generated model of a contribution of the set of localization factors to a given outcome of the at least two outcomes.

2. The computer-program product of claim 1, wherein the instructions are operable to cause the computing system to generate the computer-generated model by:
generating, based on the outcome data, the indication of the authorized extent of computational processing, and the assignment, a first computer-generated probability that the first combination of factors from the set of localization factors, contributed to a given outcome of the at least two outcomes; and
generating, based on the outcome data, the indication of the authorized extent of computational processing, and the assignment, a second computer-generated probability that the second combination of factors from the set of localization factors, contributed to a given outcome of the at least two outcomes.

3. The computer-program product of claim 2, wherein the instructions are operable to cause the computing system to compute the first computer-generated probability as a ratio of prior root cause probability of potential root causes for a first outcome of the at least two outcomes relative to an enumeration probability of an enumeration of a set of scenarios for first outcomes involving the potential root causes.

4. The computer-program product of claim 1,
wherein the indication of the authorized extent of computational processing is an extent of computational processing for generating the ranking; and
wherein the instructions are operable to cause the computing system to display, via the graphical user interface, the ranking by displaying the first combination of factors and the second combination of factors in proximity to a first computer-generated probability and a second computer-generated probability.

5. The computer-program product of claim 1, wherein the instructions are operable to cause the computing system to:
generate a test suite that provides test cases for the experiment, wherein the outcome data indicates a respective outcome from a set of outcomes for each test case of the test suite;
wherein the at least two outcomes comprise a failure indication indicating a test conducted according to the test case failed; and
display, in the graphical user interface, a ranking of the first combination of factors and the second combination of factors by displaying most likely potential causes for the failure indication.

6. The computer-program product of claim 1, wherein the instructions are operable to cause the computing system to receive the assignment by receiving, via the graphical user interface, a selection of a relativity indication, wherein the relativity indication indicates a contribution of the recipient of the assignment relative to the contribution of a different factor or combination of factors for the set of multiple factors.

7. The computer-program product of claim 1, wherein the instructions are operable to cause the computing system to receive the assignment by receiving a change, via the graphical user interface, to a computer-generated assignment.

8. The computer-program product of claim 1, wherein the instructions are operable to cause the computing system to receive the assignment by receiving, via the graphical user interface, a selection of selected factors or combination of factors, and receiving a single indication to assign to all in the selection.

9. The computer-program product of claim 1, wherein the instructions are operable to cause the computing system to receive the assignment by:
receiving, via the graphical user interface, an indication to generate a computer-generated combination of factors from the set of multiple factors; and
receiving, via the graphical user interface, an assignment for one or more generated combinations of the computer-generated combination of factors.

10. The computer-program product of claim 1, wherein the instructions are operable to cause the computing system to receive, via the graphical user interface, the assignment by receiving for a first factor of the set of multiple factors:
a first assignment specific to a first outcome of the at least two outcomes; and
a second assignment specific to a second outcome of the at least two outcomes.

11. The computer-program product of claim 1, wherein the instructions are operable to cause the computing system to:
receive, via the graphical user interface, an updated assignment for the at least one factor or the at least one combination of factors; and
update, responsive to the updated assignment, the ranking displayed in the graphical user interface.

12. The computer-program product of claim 1,
wherein the outcome data comprises at least two test cases of a same outcome of the at least two outcomes; and
wherein the instructions are operable to cause the computing system to:
generate a bipartite mapping with two sets that are disjoint and independent, wherein a first set of the two sets is derived from the at least two test cases and a second set of the two sets is derived from the set of multiple factors;
determine, based on the bipartite mapping, a scenario of combinations of factors that could account for the same outcome in the at least two test cases; and
generate the set of localization factors and the ranking based on the bipartite mapping.

13. The computer-program product of claim 11, wherein the instructions are operable to cause the computing system to:
receive, via the graphical user interface, a strength for the bipartite mapping; and
generate the ranking based on the strength for the bipartite mapping.

14. The computer-program product of claim 1, wherein the instructions are operable to cause the computing system to:
receive the assignment by receiving a set of assignments for one or more candidate causes of the outcome data; and
select the subset of the set of one or more candidate causes and combinations of candidate causes for the set of localization factors by:
generating an ordered collection for the set of localization factors;
determining, based on the resources, a limit for a quantity of candidate causes and combinations of candidate causes to generate;
selecting for the set of localization factors, according to the ordered collection and the limit, any individual candidate causes that explain the outcome data; and
selecting for the set of localization factors, according to the ordered collection and the limit, a first combination of two candidate causes from the ordered collection that has a highest combined value of any two-cause combinations from the ordered collection.

15. The computer-program product of claim 14, wherein the instructions are operable to cause the computing system to select the subset by:
starting in the ordered collection immediately after a first candidate cause of the first combination of two candidate causes; and
selecting for the set of localization factors, according to the ordered collection and the limit, a second combination of candidate causes that has a highest combined value of any remaining combinations in the ordered collection.

16. The computer-program product of claim 14, wherein the instructions are operable to cause the computing system to select the subset by:
determining that an end of the ordered collection is reached; and
processing a beginning of the ordered collection again to determine a next combination of candidate causes for the set of localization factors.

17. The computer-program product of claim 14, wherein the instructions are operable to cause the computing system to select the subset by:
determining that a quantity of two candidate causes for selection in the subset is less than the limit; and
responsive to the determining the quantity is less than the limit, selecting, according to the ordered collection and the limit, a first combination of three candidate causes from the ordered collection that has a highest combined value of any three-cause combinations from the ordered collection.

18. The computer-program product of claim 14, wherein an order of elements for the ordered collection is based on a quantity of candidate causes in a given element of the ordered collection.

19. The computer-program product of claim 1, wherein the instructions are operable to cause the computing system to receive the assignment by displaying in the graphical user interface, or using by the graphical user interface, log data of one or more experiments conducted previous to the experiment, wherein the one or more experiments involve the at least one factor or combination of factors.

20. The computer-program product of claim 1, wherein the instructions are operable to cause the computing system to:
display, in the graphical user interface, a graphical representation of the outcome data; and
identify a region in the graphical representation based on the ranking.

21. A computer-implemented method comprising:
displaying a graphical user interface comprising;
a set of multiple factors for an experiment;
a control element for controlling an extent of computational processing for the set of multiple factors; and
an input element for receiving an assignment to at least one factor or at least one combination of factors from the set of multiple factors, wherein the assignment indicates an estimation as to a contribution of a recipient of the assignment to an estimated outcome for the experiment;
receiving an indication of an authorized extent of computational processing via the control element;
based on the indication of the authorized extent of computational processing, dynamically allocating resources at a computing system for generating a set of localization factors, wherein the set of localization factors are for localizing one or more of the set of multiple factors influencing a given outcome for the experiment or an experiment model for the experiment;
receiving the assignment via the input element of the graphical user interface;
selecting a subset of a set of one or more candidate causes and combinations of candidate causes for the set of localization factors;
obtaining outcome data that is based on conducting the experiment or executing the experiment model, wherein the outcome data indicates at least two outcomes from conducting the experiment or executing the experiment model; and
controlling the graphical user interface to display a computer-generated prediction for the outcome data by generating, based on the outcome data, the indication of the authorized extent of computational processing, and the assignment, a ranking of a first combination of factors and a second combination of factors from the set of localization factors, wherein the first combination of factors and the second combination of factors are different; and
wherein the ranking is based on a computer-generated model of a contribution of the set of localization factors to a given outcome of the at least two outcomes.

22. The computer-implemented method of claim 21,
wherein the receiving the assignment comprises receiving, via the graphical user interface, a selection of a relativity indication; and
wherein the relativity indication indicates a contribution of the recipient of the assignment relative to the contribution of a different factor or combination of factors for the set of multiple factors.

23. The computer-implemented method of claim 21, wherein the receiving the assignment comprises one or more:
receiving a change, via the graphical user interface, to a computer-generated assignment; and
receiving, via the graphical user interface, a selection of selected factors or combination of factors, and receiving a single indication to assign to all in the selection.

24. The computer-implemented method of claim 21, wherein the receiving the assignment comprises:
receiving, via the graphical user interface, an indication to generate a computer-generated combination of factors from the set of multiple factors; and
receiving, via the graphical user interface, an assignment for one or more generated combinations of the computer-generated combination of factors.

25. The computer-implemented method of claim 21, wherein generating the computer-generated model comprises:
generating, based on the outcome data, the indication of the authorized extent of computational processing, and the assignment, a first computer-generated probability that the first combination of factors from the set of localization factors, contributed to a given outcome of the at least two outcomes; and
generating, based on the outcome data, the indication of the authorized extent of computational processing, and the assignment, a second computer-generated probability that the second combination of factors from the set of localization factors, contributed to a given outcome of the at least two outcomes.

26. The computer-implemented method of claim 25, wherein the method further comprises computing the first computer-generated probability as a ratio of prior root cause probability of potential root causes for a first outcome of the at least two outcomes relative to an enumeration probability of an enumeration of a set of scenarios for first outcomes involving the potential root causes.

27. The computer-implemented method of claim 21,
wherein the indication of the authorized extent of computational processing is an extent of computational processing for generating the ranking; and
wherein the computer-implemented method further comprises displaying, via the graphical user interface, the ranking by displaying the first combination of factors and the second combination of factors in proximity to a first computer-generated probability and a second computer-generated probability.

28. The computer-implemented method of claim 21,
wherein the receiving the assignment comprises receiving a set of assignments for one or more candidate causes of the outcome data; and
wherein the computer-implemented method further comprises selecting the subset of the set of one or more candidate causes and combinations of candidate causes for the set of localization factors by:
generating an ordered collection for the set of localization factors;
determining, based on the resources, a limit for a quantity of candidate causes and combinations of candidate causes to generate;
selecting for the set of localization factors, according to the ordered collection and the limit, any individual candidate causes that explain the outcome data; and
selecting for the set of localization factors, according to the ordered collection and the limit, a first combination of two candidate causes from the ordered collection that has a highest combined value of any two-cause combinations from the ordered collection.

29. The computer-implemented method of claim 21, wherein the computer-implemented method further comprises:
generating a test suite that provides test cases for the experiment, wherein the outcome data indicates a respective outcome from a set of outcomes for each test case of the test suite; and
displaying, in the graphical user interface, a ranking of the first combination of factors and the second combination of factors by displaying most likely potential causes for a failure indication, wherein the at least two outcomes comprise the failure indication indicating a test conducted according to the test case failed.

30. A computing device comprising processor and memory, the memory containing instructions executable by the processor wherein the computing device is configured to:
display a graphical user interface comprising:
a set of multiple factors for an experiment;
a control element for controlling an extent of computational processing for the set of multiple factors; and
an input element for receiving an assignment to at least one factor or at least one combination of factors from the set of multiple factors, wherein the assignment indicates an estimation as to a contribution of a recipient of the assignment to an estimated outcome for the experiment;
receive an indication of an authorized extent of computational processing via the control element;
based on the indication of the authorized extent of computational processing, dynamically allocate resources at the computing device for generating a set of localization factors, wherein the set of localization factors are for localizing one or more of the set of multiple factors influencing a given outcome for the experiment or an experiment model for the experiment;
receive the assignment via the input element of the graphical user interface;
select a subset of a set of one or more candidate causes and combinations of candidate causes for the set of localization factors;
obtain outcome data that is based on conducting the experiment or executing the experiment model, wherein the outcome data indicates at least two outcomes from conducting the experiment or executing the experiment model; and
control the graphical user interface to display a computer-generated prediction for the outcome data by generating, based on the outcome data, the indication of the authorized extent of computational processing, and the assignment, a ranking of a first combination of factors and a second combination of factors from the set of localization factors, wherein the first combination of factors and the second combination of factors are different; and
wherein the ranking is based on a computer-generated model of a contribution of the set of localization factors to a given outcome of the at least two outcomes.
